(19) United States
(12) Patent Application Publication
(10) Pub. No.: US 2022/0346912 A1
(43) Pub. Date: Nov. 3, 2022

(54) SYSTEM AND METHOD FOR DETERMINING A FORCE VECTOR ON A VIRTUAL DENTITION

(71) Applicant: 3M INNOVATIVE PROPERTIES COMPANY, St. Paul, MN (US)

(72) Inventors: Chaodi Li, Woodbury, MN (US); David K. Cinader, Jr., Woobdury, MN (US); Michael K. Domroese, Woodbury, MN (US); Richard E. Raby, Lino Lakes, MN (US)

(21) Appl. No.: 17/764,581

(22) PCT Filed: Oct. 15, 2020
(86) PCT No.: PCT/IB2020/059668

§ 371 Date: Mar. 29, 2022

Related U.S. Application Data
(60) Provisional application No. 62/915,942, filed on Oct. 16, 2019.

(51) Int. Cl. A61C 7/00; A61C 7/08

(52) U.S. Cl. CPC A61C 7/002; A61C 7/08

(57) ABSTRACT

Aspects of the present disclosure relate to a method and system of determining a first force vector of a selected point in a first position on a virtual dentition of the oral cavity based on the first aggregate force characteristic of a force member, having multiple segments, in the first configuration and determining a second force vector of the selected point in a second position on the virtual dentition based on the first aggregate force characteristic of the force member in the first configuration. The method includes determining a condition of whether the second force vector (or force magnitude thereof) is within 90 percent of the first force vector (or force magnitude thereof) at 50 percent of displacement between the first position and the second position and performing an operation based on the condition.

### BACKGROUND

The field of orthodontics relates to repositioning a patient's teeth for improved function and aesthetic appearance. Orthodontic devices and treatment methods generally involve the application of forces to move teeth into a proper bite configuration, or occlusion. As one example, orthodontic treatment may involve the use of slotted appliances, known as brackets, which are fixed to the patient's anterior, cuspid, and bicuspid teeth. A force member may be placed in the slot of each bracket and serves as a track to guide movement of the teeth to desired orientations and locations. The ends of the force member are received in appliances known as buccal tubes that are secured to the patient's molar teeth. Such dental appliances remain in the mouth of the patient and are periodically adjusted by an orthodontist until proper alignment and position is achieved.

Orthodontic treatment may also involve the use of alignment trays, such as clear or transparent, polymer-based tooth positioning trays, often referred to as clear tray aligners (CTAs) (which can also be non-transparent). For example, orthodontic treatment with CTAs may include forming a tray having shells that engage one or more teeth. Each shell may have a shape that is deformed upon being installed over the patient's teeth. The deformed position of a respective shell of the CTA may apply a force to a respective tooth toward a desired position of the tooth that is an intermediate position between an initial position of the respective tooth and a final position resulting from the orthodontic treatment. However, orthodontic treatment may require some tooth movements that are difficult for a CTA to achieve, such as, for example, tooth root movements and rotations of cuspids and bicuspids. In these instances, the forces and moments that a CTA is capable of applying directly to the surfaces of a tooth may be insufficient to achieve the desired tooth movement.

Digital dentistry is a growing trend with an increasing number of dentists using digital impressioning systems. These systems use an intra-oral scanning camera, or scanning of a traditional physical impression, and an associated processing system to generate a digital three-dimensional (3D) model of patients' teeth (e.g., a patient's maxillary and mandibular arches). The digital 3D models can then be used to make prosthodontic restorations and for orthodontic treatment planning.

The goal of the orthodontic treatment planning process is to determine where the post-treatment positions of a person's teeth (setup state) should be, given the pre-treatment positions of the teeth in a malocclusion state. This process is typically performed manually using interactive software and is a very time-consuming process. Intermediate staging of teeth from a malocclusion state to a final state may include determining accurate individual teeth motions in a way that teeth are not colliding with each other, the teeth move toward their final state, and the teeth follow optimal (preferably short) trajectories. Since each tooth has 6 degrees-of-freedom and an average arch has about 14 teeth, finding the optimal teeth trajectories from initial to final stage has a large and complex search space.

Accurate articulation is one factor in making such orthodontic treatment plans. Current data acquisition for mechanical articulation is time consuming and requires expensive analog devices. In particular, current example techniques involve a manual process using a face bow and lab articulator to capture mandibular articulation data for complex rehabilitations.

Further, a typical force member without multiple (e.g., a plurality of) segments may have a high level of applied force (normalized) drop relative to the displacement (normalized)as shown in FIG. 1. Due to the high level of force vector analysis (e.g., finite element analysis) that comes from force members with multiple segments, existing systems may not be able to utilize multiple segmented force members in their design process or design the force member to maintain a near constant force over a given displacement.

### BRIEF SUMMARY

Aspects of the present disclosure relate to a method of receiving, by a computing device, data indicative of a virtual dentition of an oral cavity of a patient, the data indicative of the virtual dentition and data indicative of a first aggregate force characteristic of a force member in a first configuration. The force member has multiple segments. The method includes determining a first force vector of a selected point in a first position on the virtual dentition of the oral cavity based on the first aggregate force characteristic of the force member in the first configuration and determining a second force vector of the selected point in a second position on the virtual dentition based on the first aggregate force characteristic of the force member in the first configuration. The method includes determining a condition of whether the second force vector (or force magnitude thereof) is within 90 percent of the first force vector (or force magnitude thereof) at 50 percent of displacement between the first position and the second position and performing, by the computing device, an operation based on the condition.

Aspects of the present disclosure also relate to a system. The system includes a computing device which further includes a processor; and a memory storing instructions that, when executed by the processor, configure the computing device to receive data indicative of a virtual dentition of an oral cavity of a patient (e.g., from an intra-oral scanner) the data indicative of the virtual dentition.

The instructions further configure the computing device to receive data indicative of a first aggregate force characteristic of a force member (e.g., from a datastore) in a first configuration. The force member includes a first segment having a first end, the first segment having a first force characteristic, and a second segment having a first end, the second segment having a second force characteristic, wherein the first end of the first segment is attached to the first end of the second segment.

The instructions further configure the computing device to determine a first force vector of a selected point in a first position on the virtual dentition of the oral cavity based on the first aggregate force characteristic of the force member in the first configuration. The computing device can determine a second force vector of the selected point in a second position on the virtual dentition based on the first aggregate force characteristic of the force member in the first configuration. The second position corresponds to tooth movement after a treatment plan. The computing device can determine a condition of whether the second force vector (or force magnitude thereof) is within 90 percent of the first force vector (or force magnitude thereof) at 50 percent of displacement between the first position and the second position and perform an operation based on the condition.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a graph 100 in accordance with one embodiment.

FIG. 2 is a block diagram illustrating an example system 200 for virtual articulation in accordance with one embodiment.

FIG. 3 illustrates an example of a digital 3D mandibular arch 300 of a patient's teeth in accordance with one embodiment.

FIG. 4 illustrates a simplified system 400 in which a server 404 and a client device 406 are communicatively coupled via a network 402.

FIG. 5 illustrates an orthodontic appliance 500 in accordance with one embodiment.

FIG. 6 illustrates an orthodontic appliance 600 in accordance with one embodiment.

FIG. 7 illustrates an orthodontic appliance 700 in accordance with one embodiment.

FIG. 8 illustrates an orthodontic appliance 800 in accordance with one embodiment.

FIG. 9 illustrates a method 900 in accordance with one embodiment.

FIG. 10 illustrates a method 1000 in accordance with one embodiment.

FIG. 11 illustrates a subroutine block 1100 in accordance with one embodiment.

FIG. 12 illustrates a method 1200 in accordance with one embodiment.

FIG. 13 illustrates a force member 1300 in accordance with one embodiment.

FIG. 14 illustrates a graph 1400 in accordance with one embodiment.

FIG. 15 illustrates a force member 1500 with segments having different material properties in accordance with one embodiment.

FIG. 16 illustrates a graph 1600 in accordance with one embodiment.

FIG. 17 illustrates a force member 1700 in accordance with one embodiment.

FIG. 18 illustrates a graph 1800 in accordance with one embodiment.

FIG. 19 illustrates a force member 1900 in accordance with one embodiment.

FIG. 20 illustrates cross-sectional patterns 2000 in accordance with one embodiment.

FIG. 21 illustrates patterns 2100 in accordance with one embodiment.

FIG. 22 illustrates patterns 2200 in accordance with one embodiment.

FIG. 23 illustrates a checkered pattern 2300 in accordance with one embodiment.

FIG. 24 illustrates patterns 2400 in accordance with one embodiment.

FIG. 25 illustrates a clear tray aligner 2500 in accordance with one embodiment.

FIG. 26 illustrates a clear tray aligner 2600 in accordance with one embodiment.

### DETAILED DESCRIPTION

“Aggregate force characteristic” refers to a force characteristic as applied to one or more spans.

“Applied force vector” refers to force applied by the force member over a given displacement of a tooth

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Contact point” refers to a portion of an orthodontic appliance where the orthodontic appliance can apply a force to a tooth. A contact point can refer to a point that is constrained only in one dimension such as pivot point, couple, or fulcrum.

“Cross-sectional dimension” refers to a dimension taken from a cross-section orthogonal to a longitudinal axis (e.g., of the force member). The dimension can depend on the shape of the cross-section. For example, the dimension can be a diameter if the cross-section is circular, largest measurement of a side if the cross-section is rhomboidal, or a length of a minor axis/major axis if the cross-section is ellipsoidal.

“Datastore” refers to a repository for persistently storing and managing collections of data which include not just repositories like databases, but also simpler store types such as simple files, emails etc.

“Displacement” refers to a distance of tooth movement after a phase of the treatment plan or after a plurality of phases (e.g., the entire treatment plan) are completed. The distance can be measured based on the direction of movement. For example, the tooth movement can be based on a translation or rotation.

“Firmware” refers to Software logic embodied as processor-executable instructions stored in read-only memories or media.

“Force characteristic” refers to a force response that occurs as a function of a material property and an orthodontic appliance structure. For example, the force characteristic can be related to modulus of elasticity, the cross-sectional moment of inertia of the segments (including dimensions in a plane), the lengths of the segments, the applied force, or combinations thereof.

“Force magnitude” refers to an amount of force, which is a scalar quantity.

“Force member” refers to the active portion of the orthodontic appliance that is elastically deformed under stress. The force member delivers force to the tooth. The force member includes, for example, an arch member, a clear tray aligner, a band, or combinations thereof.

“Force vector” refers to a representation of a force that has both magnitude and direction.

“Hardware” refers to logic embodied as analog or digital circuitry.

“Orthodontic appliance” refers to a device used to reposition at least a portion of a dentition. Can refer to (clear) tray aligners, devices that include at least an orthodontic bracket and an archwire, or combinations thereof.

“Orthodontic bracket” refers to a device that attaches to or is shaped to fit to a tooth and is designed to transmit force to the tooth. Examples include appliances such as those appearing in US Publication No. 2018/0338564, “orthodontic appliance including force member” or US Publication No. 2020/0113652, “Removable orthodontic appliance System” or US Publication No. 2019/0336247, “Elastomeric orthodontic bracket”, which could be an unconventional anchor for a force member of non-uniform cross-section or even just a connecting member between a force member and a bracket footing or tooth shell. Such devices may be formed integrally with the force member and/or bracket footings. Other examples of orthodontic brackets include connectors, stand-offs, or mounds that are integrally connected between a force member and a base or footing that interfaces with a tooth.

“Position” refers to a particular way in which a tooth is placed or arranged. Can refer to a relative position with respect to another tooth, the maxillary arch or mandibular arch, or an orientation of the tooth in three or more dimensions.

“Relaxed state” refers to a position of force member in a final position of a treatment plan while attached to orthodontic brackets when treating a patient. The relaxed state can have an average stress that depends on the force member modulus or segment geometry, segment length, and loading. In one example, the average stress is less than 15 MPa and is non-zero. The relaxed state can be used interchangeably with the term “final state” which can describe the state of the force member when the teeth reach the target locations of the treatment plan. The term relaxed state can mean that the force member is relaxed relative to a stressed state and can be under some stress.

“Segment” refers to a portion of a force member with a unique force characteristic. A plurality of segments can exist in each force member. The segment can refer to a portion of a clear tray aligner along any axis.

“Selected point” refers to a point corresponding to a position of an orthodontic bracket on a tooth.

“Software” refers to Logic implemented as processor-executable instructions in a machine memory (e.g. read/write volatile or nonvolatile memory or media).

“Span” refers to a portion of the force member between two contact points. A span can include a plurality of segments. Each span can have its own aggregate force characteristic that results from the combination of segments. For example, the span functions as a beam supported on both ends, and it may form couples or moments with the ends to transmit any variety of net forces between them, including compression, tension, torsion, bending, and/or shear.

“Stress-strain profile” refers to properties that determine how a force member will interact within a given treatment plan. Can be related to a stress-strain curve.

“Stressed state” refers to a force member in a first position of a treatment plan attached to a support when treating a patient. The stressed state can apply to clear tray aligners or any appliance with a force member that can be elastically deformed, not just cases involving brackets & wires. In one example, the stressed state can have an average stress of at least 20 MPa.

“Support” refers to a device that couples with the tooth and transmits force therethrough. If the support is an orthodontic bracket, then the support can attach to the tooth via an adhesive. If the support is a clear tray aligner, then the support can encapsulate a portion of the tooth sufficient to move the tooth with the applied force.

“Targeted position” refers to position of teeth that correspond to an ideal occlusion.

“Transition region” refers to a region between segments wherein each segment has different properties. Preferably, the transition region exists between teeth along the span.

“Treatment plan” refers to a detailed plan tailored to the repositioning of a tooth in an individual. A treatment plan can start with a plan to reposition teeth in the mandibular arch, then repositioning of teeth within the maxillary arch.

Aspects of the present disclosure relate to a system and a method of treating a patient using a force member having multiple segments. The multiple segments can be useful in implementing a treatment plan while maintaining a minimal loss of force over a given displacement. For example, the force member can limit the maximum stress in the material of a force member and allow for a design using higher nominal forces over a longer period of time without undue risk to the patient.

A force member width can be changed in the in/out direction along its length, thereby allowing for constant dimensions in the vicinity of the slot of an orthodontic bracket while increasing or decreasing the force member cross-section between orthodontic brackets to modify the force member's resiliency.

In at least one embodiment, changes in the force member shape normal to the occlusal plane can also occur. For instance, loops or bends are placed in specific locations for treating multiple teeth. In addition to flexing the force member as shown in the examples, the mechanisms are applicable to developing design strategies for rotations, tips, torques, translations, etc.

Aspects of the present disclosure can be applied to other orthodontic appliances that don't involve elongated force members but, instead, employ arch members having more organic shapes, or to appliances that concentrate forces over 2- or 3-dimensional surfaces. Some examples include Clear Tray Aligners (CTAs), spring aligners, 2D archwires, and polymeric tooth shells having integral arch members. We can apply the same design approaches to a tray by specifying the thickness or geometry of the tray in specific locations (thickness variations, crests and valleys, etc.) or by modifying material properties (modulus of elasticity, durometer, etc.).

In at least one embodiment, a force member can be embedded in the aligners along the entire arch or only in specific locations. Such a design could control the forces applied to specific teeth. Another advantage of embedding wires is minimizing creep in polymer tray aligners. Such a wire-reinforced aligner would provide more constant forces during orthodontic treatment.

In at least one embodiment, aspects of the present disclosure can relate to a computer-implemented method of designing a force member with multiple segments having different force characteristics. Due to the complex forces between each span of the force member, the resulting force vector applied to a selected point can be impossible to determine without aid of computer processors. Further, finite element analysis to the entire force member can be extremely processor intensive. Thus, being able to bypass finite element analysis using known relations of segments can be particularly advantageous.

In at least one embodiment, finite element analysis could be done beforehand as one of the tools used to create the relationships or rules used to set up the case in real-time. For example, using finite element analysis may practical in real-time as a case is being set up which would not necessarily completely bypass the use of finite element analysis.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined, without limiting the scope to the embodiments disclosed herein.

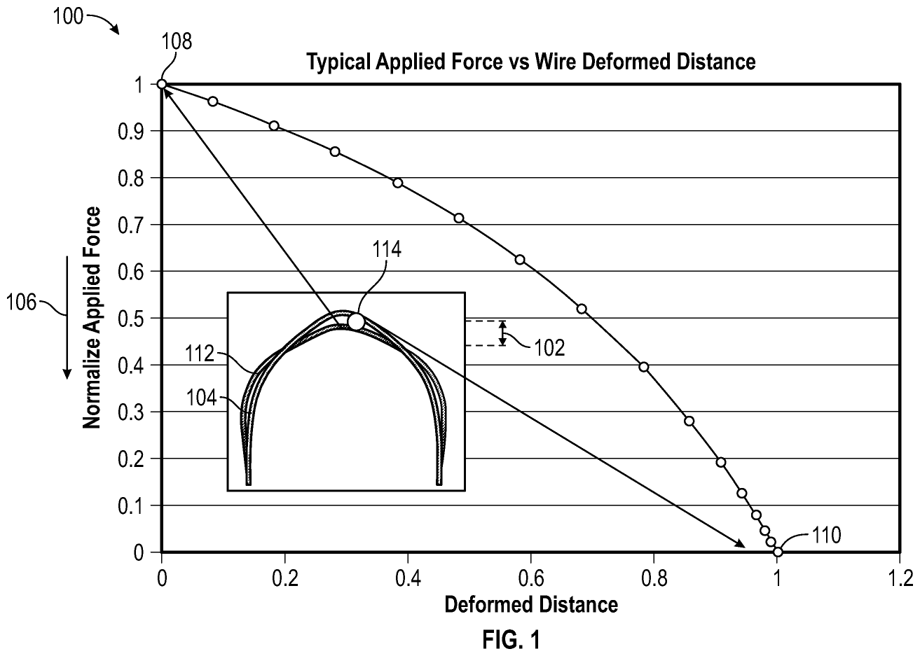

FIG. 1 illustrates a graph 100 of applied force 106 vs deformed distance 102 of a non-segmented force member 104 at point 114 between the relaxed state and stressed state. At point 108, where the applied force 106 is highest, the force member 104 can be initially engaged to the tooth and a large amount of deformation is present as shown in simulated force member 112. When the tooth moves, the force member 104 can relax back to its original state, and the force vector rapidly decreases until point 110. The relaxed shape of the force member 104 is the shape that drives the teeth.

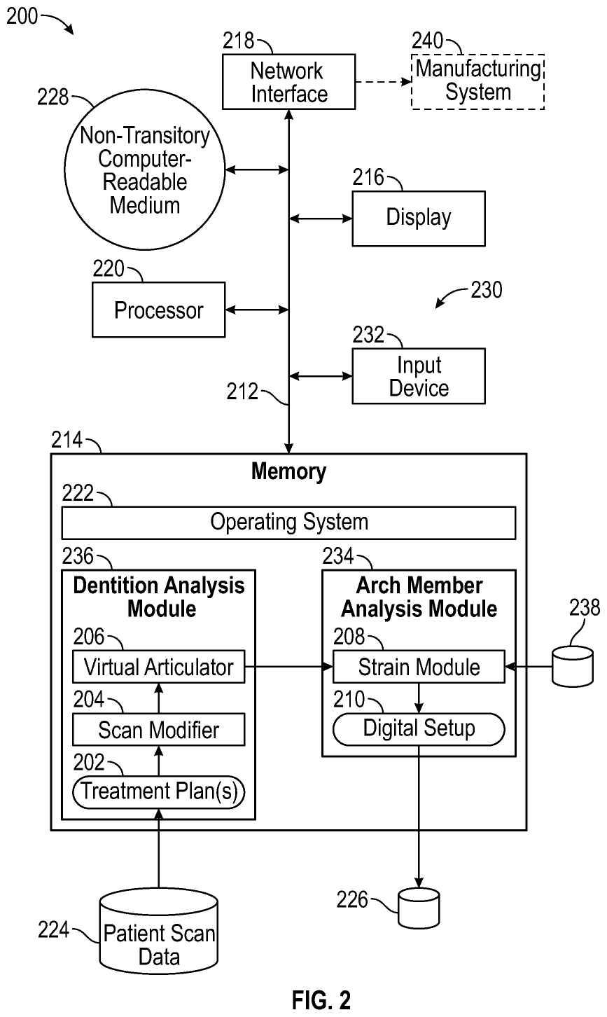

FIG. 2 illustrates several components of an exemplary system 200 in accordance with one embodiment. In various embodiments, system 200 may include a desktop PC, server, workstation, mobile phone, laptop, tablet, set-top box, appliance, or other computing device that is capable of performing operations such as those described herein. In some embodiments, system 200 may include many more components than those shown in FIG. 2. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 200 may comprise one or more physical and/or logical devices that collectively provide the functionalities described herein. In some embodiments, system 200 may comprise one or more replicated and/or distributed physical or logical devices. For example, the system 200 can include a computing device 230.

In some embodiments, system 200 may comprise one or more computing resources provisioned from a “cloud computing” provider, for example, Amazon Elastic Compute Cloud (“Amazon EC2”), provided by Amazon.com, Inc. of Seattle, Washington; Sun Cloud Compute Utility, provided by Sun Microsystems, Inc. of Santa Clara, Calif.; Windows Azure, provided by Microsoft Corporation of Redmond, Washington, and the like.

System 200 includes a bus 212 interconnecting several components including a network interface 218, a display 216, a processor 220, and a memory 214.

Memory 214 generally comprises a random-access memory (“RAM”) and permanent non-transitory mass storage device, such as a hard disk drive or solid-state drive. Memory 214 stores an operating system 222.

These and other software components may be loaded into memory 214 of system 200 using a drive mechanism (not shown) associated with a non-transitory computer-readable medium 228, such as a DVD/CD-ROM drive, memory card, network download, or the like.

Memory 214 also includes patient scan data 224. In some embodiments, system 200 may communicate with patient scan data 224 via network interface 218, a storage area network (“SAN”), a high-speed serial bus, and/or via the other suitable communication technology.

In some embodiments, patient scan data 224 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

FIG. 2 is a diagram of an example system 200 for performing virtual articulation and computing metrics from the virtual articulation using digital 3D models from intra-oral scans of a patient. System 200 can be implemented with, for example, a desktop computer, notebook computer, tablet computer, or any type of computing device. System 200 includes a computing device 230 configured to receive patient scan data 224 and store patient scan data 224 in memory 214. The memory 214 can include a dentition analysis module 236 and an arch member analysis module 234. The dentition analysis module 236 can analyze a virtual dentition of the oral cavity including projected movements of teeth. The memory 214 can also include an arch member analysis module 234 configured to determine properties of the force member sufficient to provide a force vector for the tooth. The arch member analysis module 234 can interact with the dentition analysis module 236 to determine the effect on the virtual dentition.

Patent scan data 224 may include digital 3D models of teeth or other intra-oral structures from intra-oral 3D scans or scans of impressions or castings of teeth. In some examples, patient scan data 224 may include scans of the mandibular arch (e.g., lower jaw and teeth) and the maxillary arch (e.g., upper jaw and teeth) of a patient.

Patient scan data 224 may comprise 3D models of the mandibular arch and maxillary arch of a patient. The use of digital 3D models in the dental market is becoming more prevalent. In one example, patient scan data 224 can be acquired directly in vivo using an intra-oral scanner, Cone Beam Computed Tomography (CBCT) scanning (i.e., 3D X-ray), or Magnetic Resonance Imaging (MRI). In other examples, patient scan data 224 can be acquired indirectly by scanning an impression of the teeth or a casting made from an impression of the teeth. Some examples of indirect data acquisition methods include, but are not limited to, industrial Computed Tomography (CT) scanning (i.e., 3D X-ray), laser scanning, and patterned light scanning.

Patient scan data 224 can be used for varied clinical tasks including treatment planning, crown and implant preparation, prosthodontic restorations, orthodontic setup design, orthodontic appliance design, and in diagnostic aides, for example to assess or visually illustrate tooth wear. As will be explained in more detail below, system 200 may use patient scan data 224 to perform virtual articulation at one or more stages of a dental treatment plan, calculate dynamic collision metrics based on the virtual articulation, and output the data indicative of the dynamic collision metrics in a way that allows a user to determine the efficacy of dental treatment plans, select particular dental treatment plans, and/or modify a dental treatment process.

System 200 may also include a display 216 for displaying digital 3D models from scans of intra-oral structures and a force member. In some examples, display 216 is part of computing device 230, and in other examples, display 216 may be separate from computing device 230. Display 216 can be implemented with any electronic display, for example a Cathode Ray

Tube (CRT), a liquid crystal display (LCD), light emitting diode (LED) display, or organic light emitting diode (OLED) display. The display 216 can also display the graphical user interface that a user uses to modify virtual dentition of the oral cavity via input device 232.

System 200 may further include an input device 232 for receiving user commands or other information. In some examples, input device 232 is part of computing device 230, and in other examples, input device 232 may be separate from computing device 230. Input device 232 can be implemented with any device for entering information or commands, for example a keyboard, microphone, cursor-control device, or touch screen. The components of system 200 may also be combined, e.g., a tablet computer can incorporate the processor, display and touch screen input devices into a single unit.

Intermediate staging of teeth from a malocclusion state to a final state includes determining accurate individual teeth motions in such a way that teeth have an acceptably low amount of collision with each other, the teeth move toward their final state, and the teeth follow optimal (preferably short) trajectories. Since each tooth has 6 degrees-of-freedom and an average arch has about 14 teeth, finding the optimal teeth trajectory from initial to final stage has a large and complex search space. An orthodontist may define a treatment plan that defines a target final state of the patient's teeth. The treatment plan may also define one or more desired intermediate states of the teeth as well as the treatment modalities used to achieve the target final state.

System 200 may be configured to receive a treatment plan 202. In some examples, a user (e.g., orthodontist) may input treatment plans to computing device 230 using input device 232. Computing device 230 may store the treatment plan 202 in memory 214. In some examples, treatment plan 202 may include an initial state of the virtual maxillary arch and the virtual mandibular arch as well as a target state (e.g., the final position after treatment) for the patient's teeth. Using the techniques of this disclosure described below, system 200 may perform virtual articulation to determine the efficacy of the target state for treatment plan 202. System 200 may also be configured to determine one or more intermediate states to include in treatment plan 202. In other examples, system 200 or a user may not determine intermediate states until the efficacy and desirability of the target final state is determined.

In other examples, treatment plan 202 may include one or more intermediate states as well as a target final state. Using the techniques of this disclosure described below, system 200 may perform virtual articulation at each of the intermediate or target final states to determine the efficacy of the target state for treatment plan 202.

Processor 220 may be configured to use patient scan data 224 and treatment plan 202 to perform virtual articulation and calculate metrics in accordance with the techniques of this disclosure. In the example of FIG. 2, processor 220 is configured to execute code to perform the techniques of this disclosure. The techniques described herein can be implemented in software or firmware modules, for example, for execution by processor 220 or other computing devices. In other examples, the techniques of this disclosure may be implemented in hardware modules or a combination of software and hardware.

In various examples, processor 220 may include, be, or be part of programmable processing circuitry, fixed function circuitry, one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components.

In the example of FIG. 2, arch member analysis module 234 may include scan modifier 204, virtual articulator 206, and force member strain module 208. The modules shown in FIG. 2 are just examples. The techniques of each of the aforementioned modules may be combined or separated into any number of software modules.

Scan modifier 204 may be configured to receive patient scan data 224 and treatment plan 202. As discussed above, in some examples, treatment plan 202 may define a desired final state of the patient's teeth. In other examples, treatment plan 202 may define one or more intermediate states of the patient's teeth as well as a desired final state of the teeth.

Scan modifier 204 may be configured to extract the state information for each treatment plan 202 and modify the virtual maxillary arch and the virtual mandibular arch of patient scan data 224 at the target state for each of the one or more treatment plan 202. If treatment plan 202 includes intermediate states, scan modifier 204 may be further configured to modify the virtual maxillary arch and the virtual mandibular arch of patient scan data 224 at each of the intermediate states for each of the one or more treatment plan 202. Scan modifier 204 may modify the virtual maxillary arch and the virtual mandibular arch to match the teeth positions at each of the states of treatment plan 202.

Virtual articulator 206 may receive the modified virtual maxillary arch and the modified virtual mandibular arch for each treatment plan 202 and perform virtual articulation on the modified scans. In general, virtual articulation may involve virtually moving the modified scans through various mandibular motions to simulate how a patient's teeth interact in different states during the treatment process. In one example, virtual articulator 206 may articulate the modified virtual maxillary arch and the modified virtual mandibular arch to determine contact points of the patient's teeth at the target state for each treatment plan 202. In other examples, virtual articulator 206 may articulate the modified virtual maxillary arch and the modified virtual mandibular arch to determine contact points of the patient's teeth at one or more intermediate states and at the target state for each treatment plan 202.

Virtual articulator 206 may be configured to move the modified virtual maxillary arch and the modified virtual mandibular arch through various mandibular poses to simulate a normal range of motion of a patient's teeth. Example mandibular poses may include motions, including one or more of a protrusive excursion, a retrusive excursion, a left lateral excursion, or a right lateral excursion.

Using the virtual maxillary arch as a fixed reference coordinate system, virtual articulator 206 may be configured to transform the relative relationships between the virtual maxillary arch and the virtual mandibular arch into a shared coordinate system to attain transforms describing the various mandibular poses for each individual type of articulation relative to a closed pose, in particular closed to open, closed to protrusive, closed to lateral left, and closed to lateral right. Various forms of interpolation of the mandible position of the virtual mandibular arch and orientation between the closed and respective bite pose, reflecting the mandible motion to attain that specific pose, are then possible. The overall mandibular motion in the virtual articulation model can then be expressed as composite transforms of individual articulation transforms at various stages of interpolation.

The movement of the mandible from the closed pose to any of the other poses can be described, for each pose, as the combination of a rotation matrix (the composite of three rotations around the coordinate axes x, y, z) and a translation vector of the origin of coordinates. This combination (rotation plus translation vector) is usually called a “3D transformation matrix” or more narrowly a “rigid body transform.”

In the particular case of human mandible movement, the possible movements are mechanically conditioned to the condyle and fossa, acting as a “ball joint.” This particular condition of “ball joint” movements permits describing any of those mandible movements (coming from the different poses) as a unique pure rotation (without translation) instead of the combination of a rotation plus a translation (as any generic movement requires).

By moving the modified mandibular arch through various poses relative to the modified maxillary arch, virtual articulator 206 may determine contact points of the teeth at various states of treatment plan 202 (e.g., final target states and/or one or more intermediate states).

In one example, when determining contact points, virtual articulator 206 may additionally be further configured to predict wear facets at these contact points over time resulting from various mandibular motions, such as protrusive/retrusive and left/right lateral excursions.

In other examples, virtual articulator 206 may be configured to determine whether proper canine guidance is achieved. Virtual articulator 206 may be configured to make such a determination as a result of first contact occurring between upper and lower canines as the mandible is shifted laterally (i.e., lateral excursion), thus discluding the posterior teeth (i.e., opening the gape and removing contact between opposing teeth).

In other examples, virtual articulator 206 may be configured to determine whether proper anterior guidance is achieved. Virtual articulator 206 may be configured to make such a determination as a result of first contact occurring between upper and lower incisors as the mandible is protruded, thus discluding the posterior teeth (i.e., opening the gape and removing contact between opposing teeth).

Virtual articulation adds sophistication to the treatment planning frameworks. For example, the virtual articulator 206 can also include the various force members that can be used in a treatment plan 202. Each force member can be responsive to complex positioning and stresses of orthodontic brackets.

The geometric information discussed above can be used to provide physical information to inform treatment planning and facilitate effective communication with clinicians and patients. Scores may also be combined with other information, including landmarks, tooth movement between states, and tooth position to provide holistic oral health and comfort information. Such a system would go beyond being an orthodontic tool and rather serve as a unified treatment platform for dentists, orthodontists, and others.

The arch member analysis module 234 can also include a force member strain module 208. The force member strain module 208 can be communicatively coupled to the datastore 238 having the force member force characteristic for each segment of the force member. For example, the datastore 238 can store various shapes, materials, and respective behaviors under strain for different segments of a force member.

The force member strain module 208 can take the positioning from the virtual articulator 206 related to treatment plan 202 and further determine the placement of brackets on teeth and the properties of the force member such that a treatment plan 202 can be implemented.

In at least one example, the force member strain module 208 can be used to determine the stress or strain on various points of the force member when the force member is placed on the orthodontic bracket (thus, the points on the force member correspond to contact with the orthodontic bracket). In at least one embodiment, a selected point can correspond to a position of an orthodontic bracket that is configured to engage with a segment.

The stress on the force member can vary depending on the location of the force member and be related to the positioning of the orthodontic bracket, the distance between orthodontic brackets, the shape of the force member, the material composition of the force member, the cross-section of the force member, and combinations thereof. The force member strain module 208 can use information from the virtual articulator 206 to simulate the force vectors of the force member and the effect of the stress on the virtual dentition.

In at least one embodiment, the force vector of a given point can incorporate at least one point corresponding to an adjacent orthodontic bracket. The force member strain module 208 uses the stress on virtual dentition of the oral cavity to influence a digital setup 210. The digital setup 210 can be various arrangements of segments within the force member. The digital setup 210 can be stored in datastore 226. In at least one embodiment, the datastore 226 can be accessed by a manufacturing system 240 where the force member is custom manufactured based on the patient.

In one example, a user may use the force member strain module 208 to determine a particular one of treatment plan 202 or force member configuration to use. In another example, a user may manually modify one or more of the intermediate and/or final states of the treatment plan 202 based on the dynamic collision metric. In another example, arch member analysis module 234 may automatically determine a treatment plan 202 to use based on the force member selected. In another example, arch member analysis module 234 may automatically modify one or more of the intermediate and/or final states of treatment plan 202 based on the force member stress. For example, arch member analysis module 234 may choose the treatment plan that maintains the force member force throughout the final setup. In other examples, arch member analysis module 234 may be configured to output the selected treatment plan as a recommended/suggested treatment plan that the user can review and accept.

In addition to the above techniques, arch member analysis module 234 may also include one or more user interface features where various aspects of the virtual articulation, and force member stress are displayed to a user on display 216. Virtual articulation system may be configured to output and display data indicative of the force member stress for each of the one or more treatment plans. This data could be visual in nature, such as color-coding of the contact point or areas to indicate severity of discomfort. For example, contacts that are closer to the hinge axis of the condyles (e.g., in the temporomandibular joint (TMJ), i.e., more distal or more posterior) are likely to result in greater discomfort than those that are further from the hinge axis, both for reasons of neurology and for basic reasons of increased mechanical leverage and thus force or pressure given the same input force from the masseter muscles. Arch member analysis module 234 may use different colors that indicate the severity of the stress/strain (e.g., red for high stress on the force member, yellow for medium stress, green for low stress).

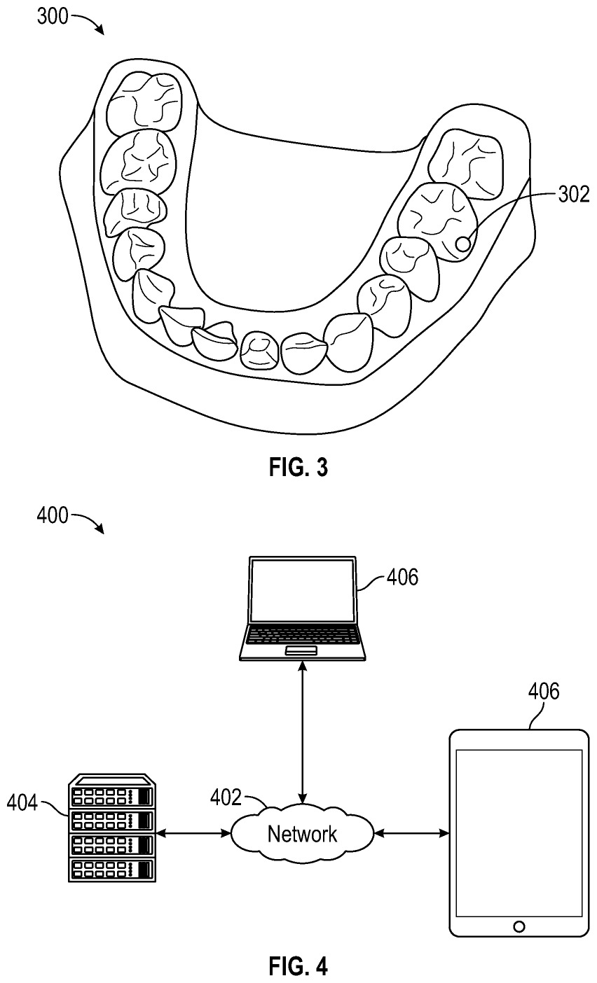

In FIG. 3, an example of a digital 3D model of a patient's mandibular arch 300 (e.g., patient scan data 224) from a scan is shown in FIG. 3. A similar scan may be made of a patient's maxillary arch which can both exist in an oral cavity of a patient. The scans of a patient's mandibular arch and maxillary arch may be referred to as a virtual mandibular arch and a virtual maxillary arch, respectively. Systems to generate digital 3D images or models based upon image sets from multiple views are disclosed in U.S. Pat. Nos. 7,956,862 and 7,605,817, both of which are incorporated herein by reference as if fully set forth. These systems can use an intra-oral scanner to obtain digital images from multiple views of teeth or other intra-oral structures, and those digital images are processed to generate a digital 3D model or scan representing the scanned teeth or other intra-oral structure. The 3D models or scans can be implemented as, for example, a polygonal mesh or point cloud representing the surface of the scanned object or intra-oral structure.

Intra-oral structures include dentition, and more typically human dentition, such as individual teeth, quadrants, full arches, pairs of arches which may be separate or in occlusion of various types, soft tissue (e.g., gingival and mucosal surfaces of the mouth, or perioral structures such as the lips, nose, cheeks, and chin), and the like, as well as bones and any other supporting or surrounding structures. Intra-oral structures can possibly include both natural structures within a mouth and artificial structures such as dental objects (e.g., prosthesis, implant, appliance, restoration, restorative component, or abutment). In an example, point 302 can be a selected point and correspond to a tooth within mandibular arch 300 to be corrected.

FIG. 4 illustrates a system 400 in which a server 404 and a client device 406 are connected to a network 402.

In various embodiments, the network 402 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 402 may also include a voice network that conveys not only voice communications, but also non-voice data such as Short Message Service (“SMS”) messages, as well as data communicated via various cellular data communication protocols, and the like.

In various embodiments, the client device 406 may include desktop PCs, mobile phones, laptops, tablets, wearable computers, or other computing devices that are capable of connecting to the network 402 and communicating with the server 404, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 404 and the client device 406 may be implemented via various combinations of physical and/or logical devices. However, it is not necessary to show such infrastructure and implementation details in FIG. 4 in order to describe an illustrative embodiment.

In at least one embodiment, the server 404 can be configured to perform analysis on the virtual dentition of the oral cavity. The patient scan data 224 can be received by the client device 406 and transmitted to the server 404. Further analysis can be performed on the server 404 of the patient scan data 224.

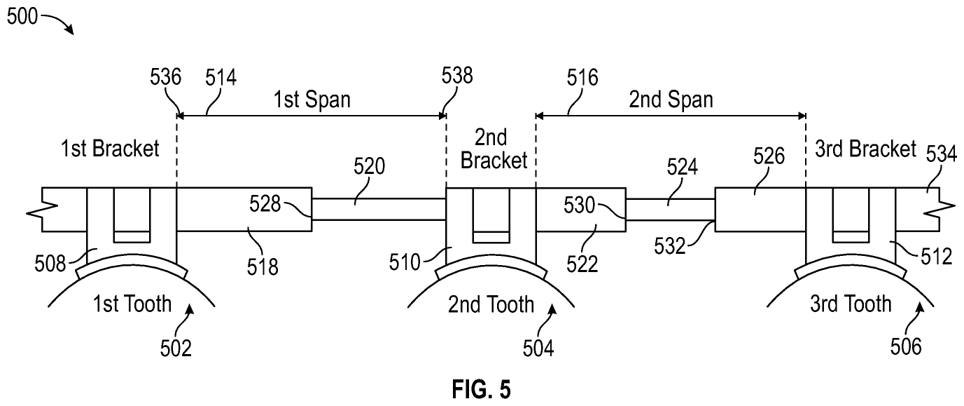

FIG. 5 illustrates an orthodontic appliance 500. The orthodontic appliance 500 can attach to a dentition of a patient. In at least one embodiment, orthodontic appliance 500 can be simulated on a virtual dentition. The dentition can include tooth 502, tooth 504, and tooth 506. The orthodontic appliance 500 can include orthodontic bracket 508, orthodontic bracket 510, and orthodontic bracket 512 which are placed at selected points on each tooth. The orthodontic appliance 500 includes force member 534 which contacts and is secured by each orthodontic bracket. In at least one embodiment, the force member 534 may be releasably engaged to orthodontic bracket 508 (as in slotted appliances or snap-on appliances). In at least one embodiment, the force member 534 can be formed integrally with brackets to form a single orthodontic appliance 500 that is either releasably engaged to the teeth (as in removable tooth shells) or bonded to the teeth (as in a finishing appliance that also serves as a retainer).

As shown, the force member 534 is formed from multiple segments, e.g., a segment 518, a segment 520, a segment 522, a segment 524, and a segment 526. Each segment to segment transition can be defined by a transition region. For example, the transition between segment 518 and segment 520 is defined by transition region 528. The transition between segment 522 and segment 524 is defined by transition region 530 and the transition between segment 524 and segment 526 is defined by transition region 532.

The space between orthodontic brackets can be referred to as a span. For example, span 514 can exist between orthodontic bracket 508 and orthodontic bracket 510, and span 516 can exist between orthodontic bracket 510 and orthodontic bracket 512. Each span can have different force characteristics from each other as the segments can have different force characteristics. The span can encompass one or more transition regions. In addition, the span can have at least two ends. For example, span 514 can have first end 536 supported by orthodontic bracket 508 and the second end 538 supported by orthodontic bracket 510. Various aggregate force characteristics are possible within each span by the arch member configurations, e.g. segment lengths, diameters (cross-sections), moduli of elasticity, etc.

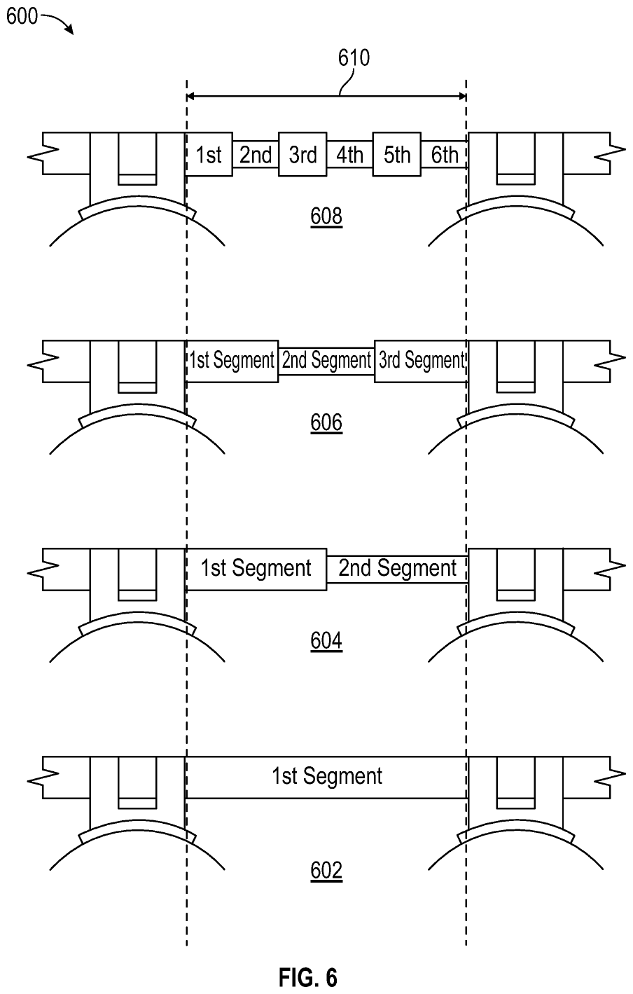

FIG. 6 illustrates orthodontic appliances 600. The orthodontic appliances 600 are shown to illustrate that any number of segments are possible per a given span 610. For example, orthodontic appliance 602 has one segment, orthodontic appliance 604 has two segments, orthodontic appliance 606 has three segments, and orthodontic appliance 608 has 6 segments (i.e., a plurality of segments).

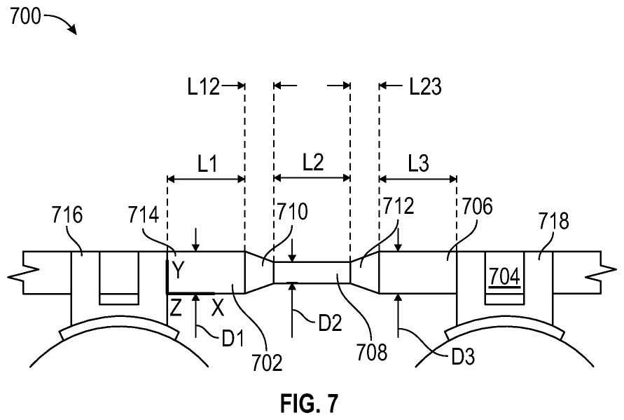

FIG. 7 illustrates orthodontic appliance 700. The orthodontic appliance 700 can have a force member 704 with multiple segments and various transition regions between the segments.

Each transition region can have its own length. It is also possible to have transitions of constant diameter but tapered in terms of modulus of elasticity, thus having a first modulus at one end and a second modulus at the other end of the transition region.

The force member 704 can be attached to orthodontic bracket 716 and orthodontic bracket 718 with a span 714 formed between the orthodontic brackets. The span 714 can include segment 702 with a cross-sectional dimension D1 (e.g., a diameter if circular), and length L1. The span 714 can also include a transition region 710 with a length L12 that tapers between segment 702 and segment 708. The segment 708 can have a length L2 and a cross-sectional dimension D2. A transition region 712 can have a length L23 that tapers from segment 708 to segment 706. Segment 706 can have a length L3 and a cross-sectional dimension D3.

For example, a first segment and a second segment can each have a first end and a second end. Both the first segment and the second segment can have different material properties from each other. The second segment can abut the first segment and the first ends can meet. In at least one embodiment, the transition region between the first segment and the second segment can have a different property than both the first segment and the second segment. In at least one embodiment, the transition region can extend no greater than 10 percent, no greater than 5 percent, or no greater than 1 percent of the length of the first segment or the second segment, whichever is longer.

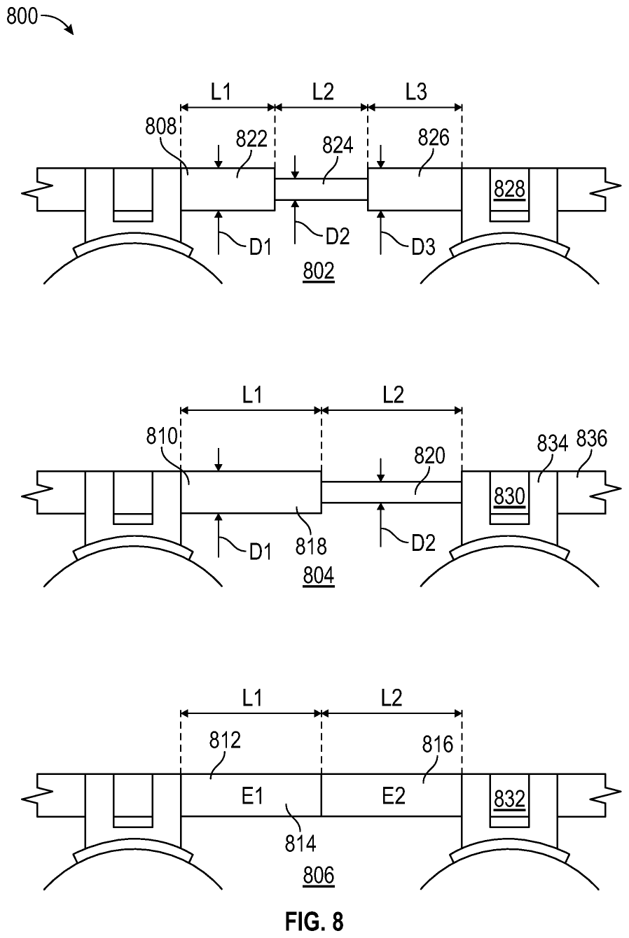

FIG. 8 illustrates orthodontic appliances 800 in various configurations that do not have an expanded transition region. For example, orthodontic appliance 802 can have a force member 828 with a span 808 that includes two transitions but have a sudden transition (thus no significant transition region). The span 808 can include segment 822 with a length L1 and a cross-sectional dimension D1. The span 808 also includes segment 824 with a length L2 and a cross-sectional dimension D2, and a segment 826 with a length L3 and a cross-sectional dimension D3. The segment 822 and segment 826 can continue to expand past the orthodontic brackets.

Orthodontic appliance 804 includes a force member 830 with a span 810. The span 810 can have a segment 818 with a length L1 and cross-sectional dimension D1 and a segment 820 with a length L2 and a cross-sectional dimension D2. In at least one embodiment, the segment 820 can transition to a segment 836 with a thicker cross-sectional dimension past the orthodontic bracket 834 (thus transitioning outside of the span 810.

Orthodontic appliance 806 includes a force member 832 with a span 812 that does not change cross-sectional areas (thus having the same general cross-sectional shape throughout the span 812). For example, span 812 can include segment 814 formed of a first material with a modulus of elasticity El and segment 816 is formed from a second material with a modulus of elasticity E2. Although the modulus of elasticity can be varied along a force member of uniform diameter, it is also possible to modify modulus of elasticity and cross-sectional dimension at the same time. In at least one embodiment, a segment can be described as having a length, a cross-sectional dimension, and a modulus of elasticity. Segments can be combined in a contiguous series within a span in any configuration to achieve a certain aggregate force characteristic.

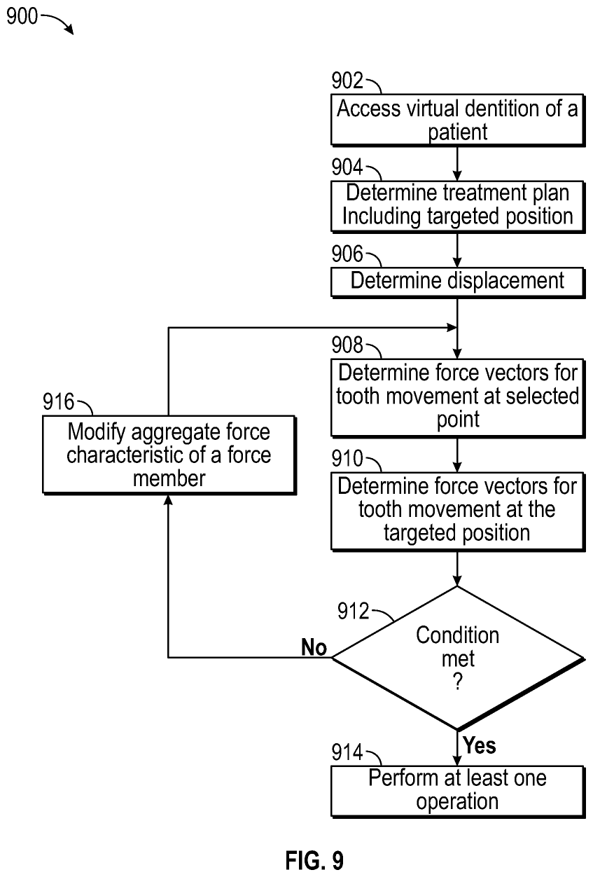

FIG. 9 illustrates a method 900 for analyzing a force member. The method 900 can use the arch member analysis system described herein to determine the arch member properties to use within an orthodontic appliance.

In block 902, the computing device can receive data indicative of a virtual dentition of an oral cavity of a patient. The data can be a series of spatial three-dimensional coordinates of various teeth. In at least one embodiment, the data indicative of the virtual dentition includes data indicative of at least one of a virtual mandibular arch representing a mandibular arch of the patient or a virtual maxillary arch representing a maxillary arch of the patient, or both the virtual maxillary arch and the virtual mandibular arch. Various tools and systems can be used to capture the virtual dentition. Examples of intraoral scanners are commercially available under the trade designation 3M True Definition Scanner from 3M Company, Inc. (Saint Paul, MN).

In block 904, the computing device can determine the treatment plan. The treatment plan can include the targeted position of the repositioned teeth. Various software can be used to develop a treatment plan, and two such examples are commercially available from 3Shape (Denmark) and BlueSkyPlan (Libertyville, Ill.). In at least one embodiment, the treatment plan can also include configurations that include the position of orthodontic brackets on teeth.

In block 906, the computing device can determine a displacement of one or more teeth and can be based on the treatment plan.

In opening loop block 908, the computing device can determine force vectors (or force magnitudes thereof) for tooth movement at a selected point. In at least one embodiment, the computing device can determine a first force vector of a selected point in a first position on the virtual dentition of the oral cavity based on the first aggregate force characteristic of the force member in the first configuration. The determination of the first force vector is described further herein.

The force vectors can be determined based on a first aggregate force characteristic of the force member in a first configuration. In at least one embodiment, the first configuration can be in a stressed state. In at least one embodiment, the force vector indicates a force applied (simulated) to an initial state of a virtual dentition and in accordance with the treatment plan.

The force vectors can be determined based on an attached configuration where the force member is modified based on a plurality of points on the virtual dentition. Thus, the force member passing through multiple brackets can ultimately determine the force vector on a particular point. In at least one embodiment, the force vector analysis can be analyzed by considering the spans, and variability of segments within the spans, the transitions between segments, the placement of the orthodontic brackets, and combinations thereof.

In block 910, the computing device can determine a force vector (or force magnitudes thereof) for the tooth movement at the targeted position. In at least one embodiment, the computing device can determine whether the position and orientation of the tooth is in a targeted position based on the treatment plan. In at least one embodiment, the computing device can determine whether the second force vector would move the tooth to the target position. In at least one embodiment, the second force vector could be determined by a user virtually moving the tooth to the targeted position (via the user interface), and then determining if the resulting forces/moments are likely to move the tooth to that position. The computation of the force vector can be based on an assumption for the position of the tooth.

In at least one embodiment, the computing device can determine a second force vector of the selected point in a second position on the virtual dentition based on the first aggregate force characteristic of the force member in the first configuration. In at least one embodiment, the second position corresponds to tooth movement after a treatment plan. For example, a user can modify the position of the teeth in the virtual dentition of the oral cavity based on the progression with the treatment plan. The position of the teeth can progress with each step of the treatment plan and are based on incremental movements over time. At each movement, the position of the selected point relative to another orthodontic bracket location (e.g., displacement) can change and can impact the force delivered by the force member in the stressed state. This “final” force vector can be a result of a relaxed state of the force member.

In at least one embodiment, block 910 starts with a desired force on a tooth and ends by determining a force member configuration (segment lengths, cross-sections, and materials) that deliver that force. In at least one embodiment, the force magnitude, as opposed to the force vector can be more useful (since the direction will be determined inherently by the force member as it relaxes toward the equilibrium shape, which defines the target positions/orientations of the teeth).

In decision block 912, the computing device can determine whether a condition is present. For example, the computing device can determine a condition of whether the second force vector is within 99, 95, 90, 85, or 80 percent of the first force vector when a point is moved to at least 30 percent, at least 40, or at least 50 percent of displacement between the first position and the second position.

In block 916, in response to the condition not being met, the computing device can modify properties of a span or a segment of a force member. For example, modifying properties can include accessing data indicative of a second aggregate force characteristic of the force member in a second configuration which is comparable to opening loop block 908 with the different segment properties selected for the force member. The second configuration can be any combination of segments that are arranged differently from the first configuration. For example, the first configuration of the force member can have a first combination of segments and the second configuration of the force member can have a second combination of segments. Based on a detailed mechanical analysis, values of specified variables (for example, the maximum force and travel distance) can be obtained by adjusting the segment cross-sections or any material property. By fine-tuning the segments, a relatively constant applied wire force can be applied over a large range of travel.

In at least one embodiment, the aggregate force characteristic of the force member can also include the stress-strain profile of individual segments of the force member. The stress-strain profile can also include various combinations of or portions of segments as they relate to two or more individual segments. The stress-strain profile can also include various combinations of segments as they relate to the force member as a whole.

The stress-strain profile can be measured based on the stress simulated on various points on the force member. For example, the stress can be simulated between two segments, between three segments, or at the distal ends of the force member.

In at least one embodiment, the computing device can recommend changes to the first force characteristic or the second force characteristic of the force member that affects a force vector.

In at least one embodiment, the computing device can assign an order to how an aggregate force characteristic is modified. For example, 1) arch member/aligner type, 2) shape, 3) cross-sectional dimension, 4) modulus, 5) lengths of segments between spans.

In the second iteration of opening loop block 908, the computing device can determine a force vector of the selected point in the first position on the virtual dentition based on the updated aggregate force characteristic of the force member in the second configuration.

In the second iteration of block 910, the computing device can determine a force vector of the selected point in the second position on the virtual dentition based on the second aggregate force characteristic. In the second iteration of decision block 912, the computing device can determine whether a condition is present. For example, the condition can include whether the new force vector is within 90 percent of the former force vector at 50 percent of displacement between the first position and the second position.

In closing loop block 914, the computing device can perform at least one operation in response to the condition being met.

In at least one embodiment, the operation can be transmitting a representation of the force member to a manufacturing system. For example, the representation can be a digital image or file relating to the specifications of the force member. In at least one embodiment, the representation can depict some (e.g., less than all segments) or all of the force member. For example, the custom orthodontics (representing one out of three segments) can be sent to a manufacturing system to produce a force member to be used with two orthodontic brackets.

The manufacturing system can be a system that is configured to manufacture metallic or thermoplastic components, such as force members. The manufacturing system can also refer to an inventory management system where previously manufactured force members are cataloged and categorized. The inventory management system can identify the force member fulfilling the condition.

In at least one embodiment, the operation can include outputting, via a display of the computing device, a graphical user interface indicating at least a portion of the virtual dentition in the second position. The graphical user interface can also include a representation of the force member on the virtual dentition. The computing device can visually identify the stresses on the force member.

In at least one embodiment, the operation can be determining one or more treatment plans for the patient based at least in part on the determined second force vector. For example, if the condition is present, then the computing device can use the force member in a different configuration to develop another treatment plan. In at least one embodiment, the treatment plan can be more aggressive and perform additional displacement on one or more teeth.

In at least one embodiment, the operation can include determining whether a position and orientation of a tooth of the virtual dentition is in a targeted position based on the second force vector. For example, the computing device can determine whether the force member would result in the correct position and orientation of a tooth in accordance with the treatment plan once the condition is met.

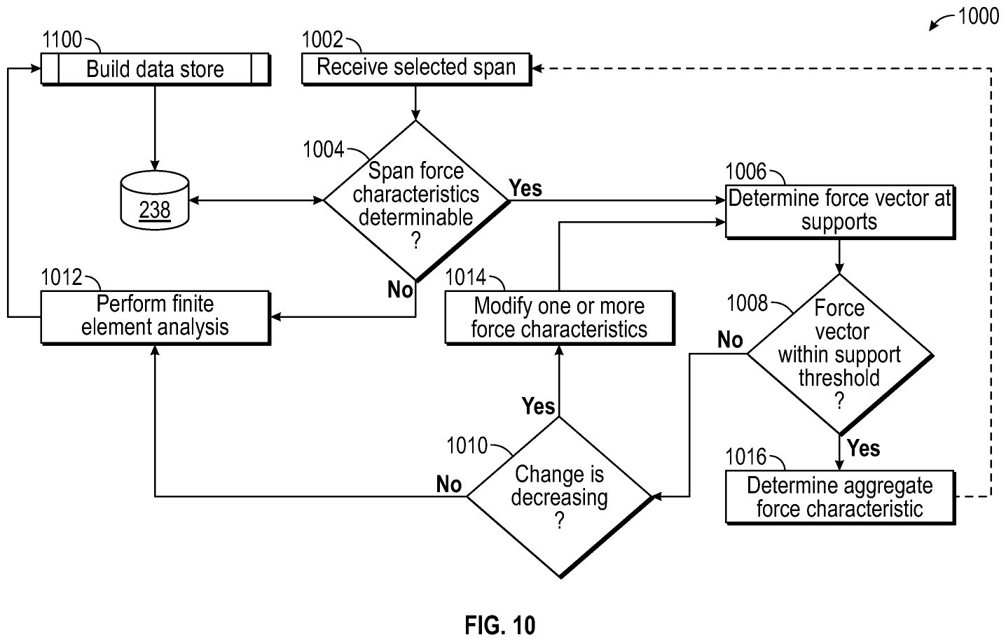

FIG. 10 illustrates a method 1000 of determining a force vector for a force member based on a treatment plan. The method 1000 can be based on selected spans of the force member between teeth in the virtual dentition. By selecting spans, as opposed to analyzing all the segments of entire force members via finite element analysis, the individual effects of the force characteristics on a support (e.g., orthodontic bracket) can be isolated, then aggregated with other supports, which can reduce the overall computational load on the computing device. Aspects of method 1000 can apply to opening loop block 908 and block 910.

In method 1000, the computing device can receive a selected span in block 1002. In at least one embodiment, the span can be selected by a user in a graphical user interface. The span is described herein. The non-selected spans can be selected at a later time.

In subroutine block 1100, the computing device can build a datastore 238. The datastore 238 can be populated with data regarding each effect of a segment (e.g., composite beam formulae). In at least one embodiment, the datastore 238 is a relational datastore (e.g., database) and might include a treatment table, a force member table, and a segment table, wherein a treatment might relate to a plurality of arch members (not just for 2 arches but for a plurality of treatment stages including either 1 or 2 arches each), and a force member might relate to a plurality of segments. A segment might include a mesial distance from midline and a distal distance from midline (thus defining the length as well as beginning and ending position), cross-sectional geometry (as a polygon), cross-sectional moment of inertia (as a scalar value), reference to a material, reference to a mesial segment (in the same quadrant or in the opposite quadrant if the mesial-most segment), and reference to a distal segment (if not a terminal end of the force member).

A material table might include entries for each material, wherein a material has properties of name, chemical formula or alloy composition, modulus of elasticity, % elongation before break, yield strength, ultimate strength, etc. The relational datastore might also include a bracket table, wherein each bracket entry constitutes a standard set of dimensions for a library of brackets, such as slot width, slot depth, slot length, in/out, torque, angulation, hook location, intended teeth, material, bracket series, version number, base-to-slot transform, etc. The relational datastore might include a bracket instance table, wherein each entry contains a reference to a parent arch form, a reference to a standard library bracket, a distance from midline indicating the bracket's position along the force member, a bracket base transform relative to a tooth, arch, or mouth, and/or a bracket slot transform relative to a tooth, arch, or mouth (technically, only one transform is needed if a standard bracket is used, and the base-to-slot transform is stored in the bracket library). Alternatively, the force member table could reference a list of library brackets along with their respective distances from the arch midline. For most cases it may suffice to reference a fixed number of brackets that correspond to the expected teeth in a normal adult dentition (max of 16 per arch, including 3^{rd} molars or “wisdom teeth”). However, a small percentage of cases may have supernumerary teeth, which are extra, unexpected teeth. These may be accounted for using the aforementioned relational datastore wherein a bracket instance table has entries that reference a force member, because the table can be inherently variable in length. Other structures, such as linked lists, XML files, or BLOBs (Binary Large Objects) can also account for such variability. It is worth noting that depending on how the segments of a force member are defined and where each bracket lies along the length of the force member, the segments between any 2 brackets can vary in configuration to form a beam of variable cross-section. The bending characteristics of each beam, supported on each end by a bracket, may be determined by the characteristics of the one or more force member segments lying between the brackets, the bracket characteristics, and the orientations of the brackets (individual instances of brackets applied to a specific patient's teeth).

In at least one embodiment, the data can be for each segment and include: material properties (e.g., Young's modulus and Poisson's ratio); segment arc geometry (e.g., center line point coordinates along the arc); arc cross section geometry (e.g., circular, rectangular, ellipse); size (e.g., radius) and orientation, and combinations thereof. The force member can have a plurality of segments. Each segment of the force member can have one or more force characteristics that change the material property and geometry of the force member as a whole.

For example, material and geometric properties of an arch member can include geometric cross section, material composition, length of segment(s), shape of multiple segments, shape of force member, and combinations thereof.

In decision block 1004, the computing device can determine whether span force characteristics are determinable from the datastore 238. For example, a force characteristic for a span can be determinable if the data to determine the force characteristic is present in the datastore 238. The datastore 238 can contain data relating to the associations of various segments. For example, the datastore 238 can include data indicating the degree to which increasing force member diameter of any segment in a span increases magnitude of force delivery. The datastore 238 can include data indicating that increasing force member diameter in the plane of bending increases the magnitude of force delivery by approximately the cube of the increase. The datastore 238 can include data indicating that increasing arch member diameter in a direction normal to the plane of bending increases the magnitude of force delivery approximately proportional to the increase. The datastore 238 can include data indicating the degree to which increasing the length of a larger diameter segment while decreasing the length of a smaller diameter segment in a span results in a greater magnitude of force delivery. The datastore 238 can include data indicating the degree to which increasing the modulus of elasticity of any segment in a span increases the magnitude of force delivery. The datastore 238 can include data indicating the degree to which increasing the length of a higher modulus segment while decreasing the length of a lower modulus segment in a span results in a greater magnitude of force delivery.

If the span force characteristics are not determinable from the datastore 238, then the computing device can perform finite element analysis in block 1012. Three-dimensional finite element analysis is the tool of choice for handling arbitrary cases with all possible degrees of freedom. Finite element analysis can analyze a system of forces along the entire force member (including multiple segments) simultaneously, albeit at a heavy processing cost.

If the force characteristics of the span are determinable by datastore 238, then the method 1000 continues to block 1006. In block 1006, the computing device can determine span forces at supports (e.g., orthodontic brackets). In at least one embodiment, the span forces can be associated with the force vectors and can be based on the force characteristics and composite beam formulas from datastore 238.

In at least one embodiment, block 1006, decision block 1008, decision block 1010, and block 1014 can be iterative for a particular span of the force member. Once the force vector for a span is determined to be within a support threshold in decision block 1008, then another span can be selected in block 1002. Block 1016 can be returned by the computing device to further determine the aggregate force characteristic (for multiple spans) of the force member.

With respect to block 1006, the force vector (or force magnitude thereof) determination can relate to a span of the force member. The span of the force member can be a length of force member between at least two orthodontic brackets (i.e., the selected point and a second point corresponding to an adjacent orthodontic bracket). Adjacent orthodontic brackets can impact the force vector provided by a force member. In at least one embodiment, the span can include a length of force member between at least two adjacent orthodontic brackets.

In at least one embodiment, the computing device can show the force acting on a bracket as a result of one or two neighboring beams (lengths of force member, each comprised of one or more segments, preferably three segments each; only one neighboring beam in the case of a distal-most bracket along a force member). In at least one embodiment, the torsional forces and compound bends in a force member between brackets can be ignored to simplify processing by the computing device.

It is the aim of this invention to both achieve a force magnitude that is in a safe and effective range and to deliver as constant a force as possible over the longest range of expression as possible. In some embodiments, there may be a clear relationship between force magnitude and the configuration (dimensions, shapes, and materials) of the force member segments between brackets.

In other embodiments, however (depending on complexity), an iterative approach may be required to determine configuration. For example, a first configuration may be set, and the force computed as a function of the configuration.

If the force vector (or force magnitude thereof) is not within a support threshold (which is related to the treatment plan) in decision block 1008, then the computing device can determine if the change in force vectors (or force magnitudes thereof) (between a first iteration and a second iteration) is decreasing in decision block 1010. If the change in force vectors (or force magnitude thereof) is not decreasing, then other force characteristics can be modified in block 1014 or the computing device can perform finite element analysis in block 1012. In at least one embodiment, whether the computing device performs block 1014 or block 1012 can be dependent on the change between a first iteration and a second iteration.

In block 1014, the computing device can modify a force characteristic of the segment in the span. For example, if the force is too great, then one or more parameters in the configuration may be changed in a direction (i.e. + or −) that is known to decrease the force. For example, decreasing any of the segment diameters (or cross-sectional moments of inertia in the plane of bending) will decrease the force.

Increasing the length of a segment having smaller diameter while decreasing the length of one or both neighboring segments will decrease the force. Decreasing the modulus of elasticity of any segment in the given span will decrease the force. The opposite is true for force increases. Any or all of these parameters may be changed by a given increment or set of increments in the direction that pushes the result in the direction of the target. Subsequent iterations should test whether the resultant force is greater than, nearly equal to (within a tolerance), or less than the desired force. In response, one or more parameters of the configuration should be changed in the according direction (+ or −) and by a magnitude that at least coarsely scales to the difference between the computed force magnitude and the desired force magnitude.

As one example, the increment of change in parameter value(s) might be constant for each iteration until the sign of the difference changes (e.g. from + to −), then a parameter value changes sign and reduces by ½ in magnitude on the next iteration. This approach reduces overshoot of the target on each iteration and leads to convergence in the fashion of a binary search. A more sophisticated approach might compute the necessary change in input parameter(s) to achieve a more measured output value, although not necessarily an exact value. As such, the step toward the target would be more proportional to the error, rather than an arbitrary ½ of the error.

As another pass, or possibly in the same pass, instead of the target being a scalar force value, the target might be a slope of the force vs. displacement curve for the span of force member in question. Similarly, the target might be a percent of desired force achieved over a given length of expression, or a length of expression achieved within a given tolerance of the desired force value, or some other measure involving the aggregate force characteristic.

In at least one embodiment, to avoid perpetual toggling between the same increased and decreased values, and instead converge on the support threshold, the computing device can store the amount of increase or decrease from the previous iteration (in terms of absolute value) and reduce the amount from that in the current iteration.

In at least one embodiment, the resultant force on any given support is the vector sum of the forces exerted by each of the one or two spans on either side of the support. In the case of clear tray aligners this could be a plurality of forces acting on a single contact point or contact area. The force member and the support couplings can preferably be a rigid coupling, so the forces in each span can be computed independently. In at least one embodiment, removable appliance concepts that include isolated tooth shells and arch members or jumpers between them can exhibit the most control due to a lack of sliding mechanics. Clear tray aligners, in contrast, have very little control due to the contact points being rather indefinite and moments from any given span efficiently transmitting to its adjacent span(s) which can add degrees of freedom to the system of forces applicable to aspects of the present disclosure.

In at least one embodiment, method 1000 computes the forces at the end of each span in isolation and only couples the forces from either side of a support into a resultant force. In at least one embodiment, the method 1000 can also apply when the forces of two or more adjacent spans are computed with some form of coupling between the spans.

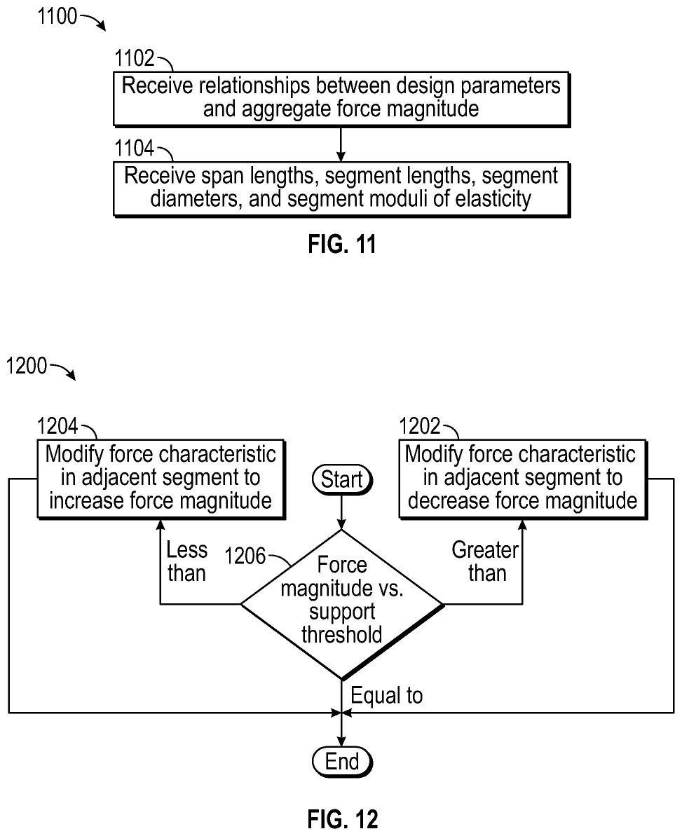

FIG. 11 illustrates an embodiment of a subroutine block 1100 where the computing device can build the datastore 238. Building the datastore 238 can include populating a datastore 238 with data relating to the relationships of various segments to one or more spans of the force member. In at least one embodiment, the subroutine block 1100 can include block 1102.

In block 1102, the computing device can receive relationships between design parameters (e.g., force characteristics) of a segment and aggregate force characteristics/magnitudes.

In block 1104, the computing device can receive span lengths, segment lengths, segment diameters (cross-sectional dimension) and segment modulus of elasticity that correspond to the design parameters of a segment.

FIG. 12 illustrates a method 1200 for modifying a force characteristic in a force member. The method 1200 can be an embodiment of block 1014.

The method 1200 can start at decision block 1206 where a force magnitude obtained from a simulation or the datastore 238 is evaluated against a support threshold.

If the force magnitude is less than the support threshold, then the computing device can modify a force characteristic in adjacent segment to increase the force magnitude in block 1204. For example, the computing device can increase force member diameter of one or more segments. In another example the computing device can also increase the length of a larger diameter segment while decreasing the length of a smaller diameter segment. In another example, the computing device can increase the modulus of elasticity of one or more segments. In another example, the computing device can increase the length of a higher modulus segment while decreasing the length of smaller modulus segment.

If the force magnitude is greater than the support threshold, then the computing device can modify the force characteristic in an adjacent segment to decrease the force magnitude in block 1202. For example, the computing device can decrease the force member diameter of one or more segments. In another example, the computing device can decrease the length of a larger diameter segment while increasing the length of a smaller diameter segment. In another example, the computing device can decrease the modulus of elasticity of one or more segments.

In another example, the computing device can decrease the length of a higher modulus segment while increasing the length of smaller modulus segment.

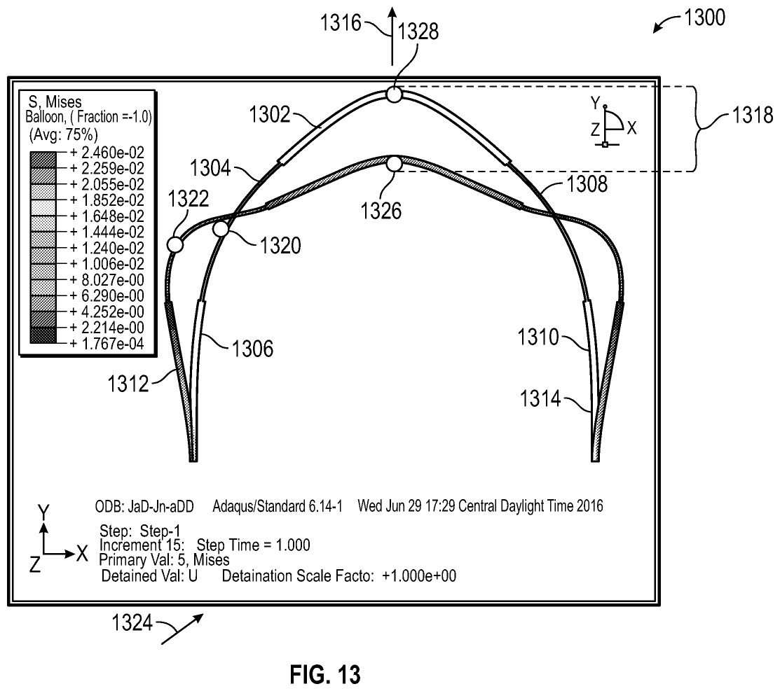

FIG. 13 illustrates an example force member 1300 with multiple segments each having different geometric cross sections and lengths. Force member 1300 can have segment 1306, segment 1304, segment 1302, segment 1308, and segment 1310. Segment 1306 and segment 1310, and segment 1304 and segment 1308, can have the same properties and force characteristics, or each segment can have different force characteristics. For example, segment 1306 can be thicker than segment 1304, which can lead to a different force characteristic. The force member 1300 as a whole can be arch shaped, which can also impact the aggregate force characteristics. The example provided represents a case having only three brackets, one positioned at the midline and one at each distal end of the force member. Other examples (as used in an oral cavity) would likely have many more brackets, and the span lengths between brackets would be much shorter. As such, the segments of various cross-sections and materials comprising a span would be even shorter. Nevertheless, the effect of flatting the force vs. displacement curve (i.e., a force-displacement curve) for each span can still be achieved.

As shown, the aggregate force characteristic can include the maximum force, the travel distance, and the force gradient. The force member 1300 can be in a relaxed state 1314 and a stressed state 1312. As the force member 1300 is expressed over a displacement 1318 (e.g., from first position 1326 in the stressed state 1312 and the second position 1328 in the relaxed state 1314), then the force member 1300 can produce a force vector 1316 which varies over the displacement 1318. This varying force vector 1316 can also be illustrated in a stress-strain profile.

In at least one embodiment, various points along the force member 1300 can have different stress-strain profiles. For example, the first position 1322 in the stressed state 1312 can have a displacement with the second position 1320 in the relaxed state 1314 that is different than displacement 1318 and produce a force vector 1324 that is different from force vector 1316. The aggregate of these various force vectors across the entire force member 1300, can be referred to as the aggregate force vector. In at least one embodiment, the first position 1326 and second position 1328 can correspond to a contact point on an orthodontic bracket. Although shown in a planar configuration, the force member 1300 as used herein, can also be bent according to a treatment plan and the force vector predicted within a three-dimensional space.

In at least one embodiment, force is only delivered to a bracket as a result of a definite coupling. Thus, forces at different points refers to possible bracket positions along the force member. Intermediate contact points between brackets would be undesirable as these would constitute interference with the force-displacement curve and thus the treatment plan. An example of intermediate contacts would be the force member contacting one or more teeth or auxiliary appliances at point(s) between the brackets for some duration of treatment.

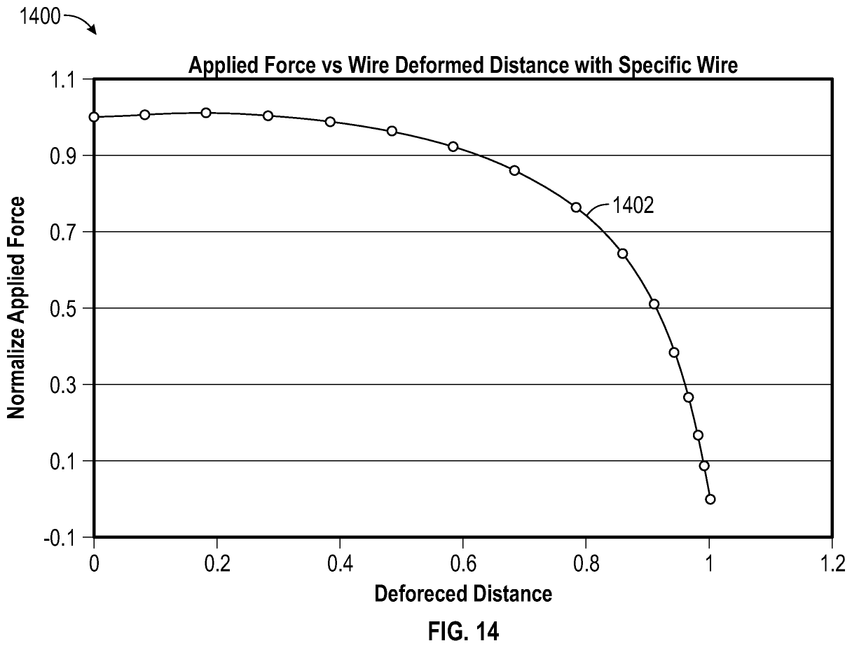

FIG. 14 illustrates a graph 1400 of an applied force versus a deformed distance (normalized) for the force member 1300. The normalized force/displacement responses are shown in graph 1400. In at least one embodiment, the plot 1402 can be representative of the stress-strain profile of force member 1300. For example, force member 1300 illustrates that an applied force/force vector drops less than 10% in the first 50% of displacement (i.e., displacement 1318). In at least one embodiment, the plot 1402 can be related to a single point, e.g., first position 1326.

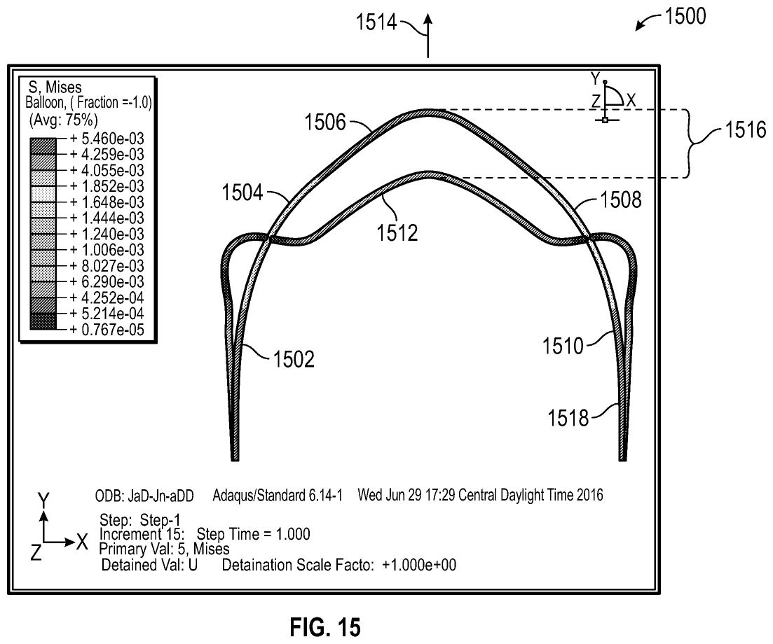

FIG. 15 illustrates a force member 1500 that has segments with different material compositions. For example, the force member 1500 can include segment 1502, segment 1504, segment 1506, segment 1508, and segment 1510. Segment 1502 and segment 1510, and segment 1504 and segment 1508, can each be formed out of the same material and cross-section and yet have different force characteristics relative to each other. In another embodiment, segments 1502 and 1510, or 1504 and 1508 could each be a different material to obtain a different modulus of elasticity, such as 2 different polymers. An example of same material but different modulus might be stainless steel, titanium, or nick-titanium that has been selectively tempered or annealed along its length. For example, the segments having a lower modulus of elasticity can be used at certain locations along the length of the force member 1500. The force characteristic can result from a material property of modulus of elasticity, cross-sectional dimension, segment length, geometric shape, or combinations thereof.

The force member 1500 can have a relaxed state 1518 and a stressed state 1512. A point on the force member can have a displacement of distance 1516. Based on the material properties, the computing device can predict a force vector 1514 from a stress-strain profile. As shown, the segment 1504 can have a lower stress than segment 1502.

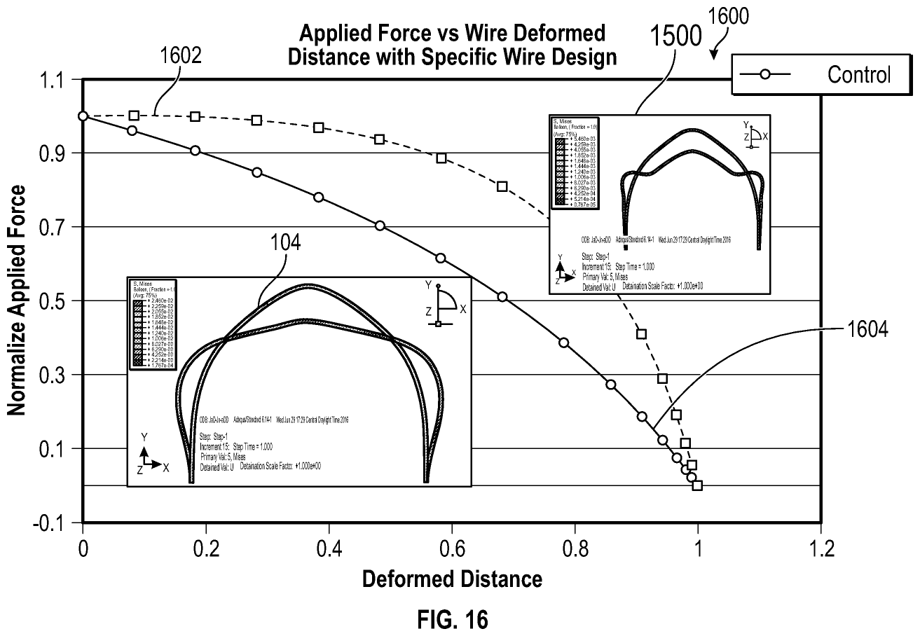

FIG. 16 illustrates a graph 1600 that shows a comparison of applied force vs deformed distance for force member 104 and force member 1500 with multiple segments. By introducing a more resilient segment of wire into the force member 1500, buckling under axial compression occurs at a very predictable location, and the compressive force is translated into bending moments. The deformation can occur in the segment of wire having the reduced moment of inertia or modulus of elasticity.

The result of the multiple segments can be a more constant force over a given deformed distance as shown in plot 1602 (which corresponds with force member 1500) and plot 1604 (which corresponds to force member 104).

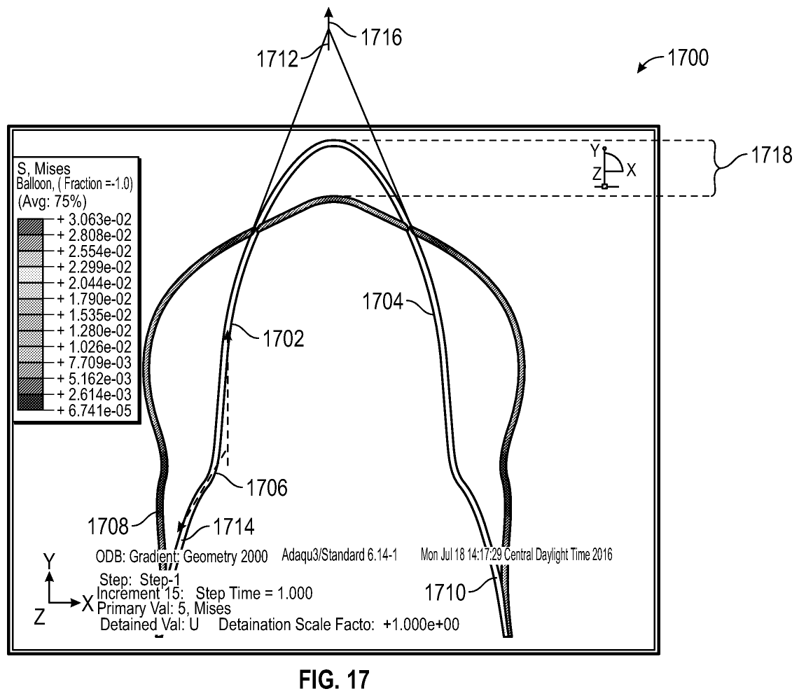

FIG. 17 illustrates a force member 1700 using a particular geometry. For example, force member 1700 can have specific crests and valleys. The force member 1700 can be uniform in composition, modulus of elasticity, and cross-section but vary in geometry. For example, the force member 1700 can have multiple segments; segment 1714, segment 1702, and segment 1704. The angle 1706 can be formed between segment 1714 and segment 1702, and angle 1712 can be formed between segment 1702 and segment 1704. In at least one embodiment, the angle 1706 is greater than angle 1712.

The force member 1700 can have a deformed state 1708 and a relaxed state 1710. The relaxed state 1710 can have a particular stress-strain profile and result in force vector 1716 when transitioning from the stressed state to the relaxed state. A point in the force member 1700 can be displaced by distance 1718. The force vector 1716 is variable over distance 1718.

Force member 1700 can be the result of deliberate shape changes in the force member which can shape the buckling regions in a controlled manner. For example, if a segment is oriented such that it lies substantially coaxial to a force vector, the segment may experience some amount of compression. However, given that a perfect coaxial alignment is unlikely, some lateral component of force will be exerted, and this will lead to bending of the segment.

Once bending occurs, the coaxial alignment is further compromised, and yet a greater component of the force results in lateral motion and bending of the force member 1700. If the force member 1700 has a coaxially-oriented segment and an off-axis segment that is angled relative to the force axis, the coaxial segment can initially resist deformation, and bending can occur in the off-axis segment and at the joint between the two segments. Bending can be an easier mode of deformation than full compression or tension. This is due to only portions of the force member 1700 cross-section being under stress during bending, as opposed to the entire wire cross-section being under stress during compression or tension.

By introducing bends in the force member 1700 at strategic locations relative to the applied force axis, wire deformation due to bending moments can be achieved in a controlled manner. These bending moments can be bi-modal or multi-modal, depending on the number and orientation of segments. Note that the amount of deflection or displacement of the wire is proportional to the length of the segment in bending and the sine of the angle between the wire axis and the force axis. In other words, longer segments bend easier, and more off-axis segments bend easier. The converse can result in segments that are more resistant to deformation.

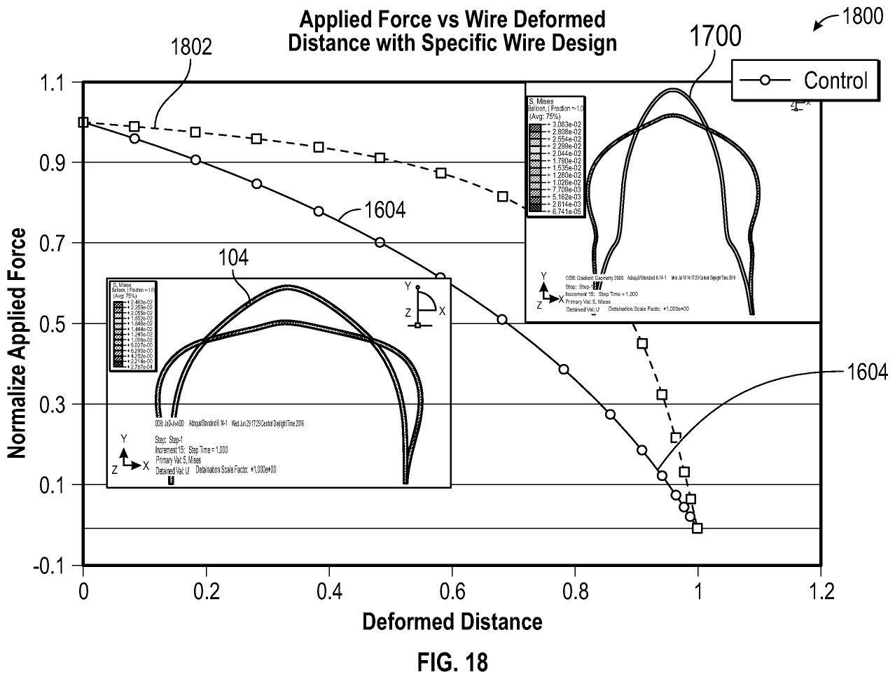

FIG. 18 illustrates graph 1800 that compares the force-displacement of force member 1700 with force member 104. As illustrated by plot 1604 and plot 1802, applied force (via force vector) of force member 1700 drops more slowly than the force member 104 as the wire is expressed in the first portion of displacement (starting from zero deformed distance).

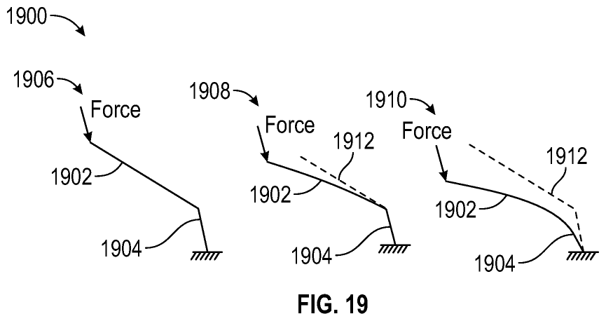

FIG. 19 illustrates a force member 1900 in various states of stress. In force member 1900, the segment 1902 is longer than segment 1904. The force member 1900 is shown in a relaxed state 1906, a semi-relaxed state 1908, and a stressed state 1910.

As force member 1900 deformation occurs, the orientation of the segment relative to the applied force vector can change. In at least one embodiment, a dynamic behavior is exploited to achieve a non-linear force/displacement response curve in at least a portion of the orthodontic appliance. For example, in force member 1900, very little deformation is needed to compromise the generally coaxial orientation of the segment 1902 relative to the applied force vector, and force member 1900 quickly undergoes at least some amount of bending as shown in semi-relaxed state 1908 in which segment 1902 bends relative to axis 1912.

While the segment 1904 may be further from the applied force axis 1912, the amount of deformation is limited by its short length and higher force needed to cause deflection. Thus, the segment 1902 continues to experience greater deformation. As segment 1902 continues to deform, the component of the force vector perpendicular to the end of the wire segment increases in magnitude, and bending becomes easier. However, as the magnitude of deflection increases, so too does the amount of normalized force required to bend the force member 1900. So, as this force rises, greater deformation begins to occur in the segment 1904 where higher forces are required to achieve bending. As the segment 1904 gets further from the applied force vector axis 1912, bending in segment 1904 gets easier, too, until the deflection is so great that the linear spring force function dominates. This is further described by Tarsicio Belendez, Cristian Neipp, Augusto Belendez, Large and small deflections of a cantilever beam, Eur. J. Phys. vol 23, page 371, (8 May 2002).

Thus, bending dynamics can be exploited to achieve a non-linear response from the force member. The bending moments of the various segments combine in ways that allow the most active regions of force member 1900 to change in both shape and orientation as the segment 1902 bends. The individual response curves dominate over different ranges of force, but they overlap one another and sum together.

Through specification of the force member 1900 cross-section, material properties, relaxed shape, and combinations thereof, the deformed force member 1900 shape can be controlled. In addition, such force members can apply relatively constant forces to the teeth as they move during a treatment plan.

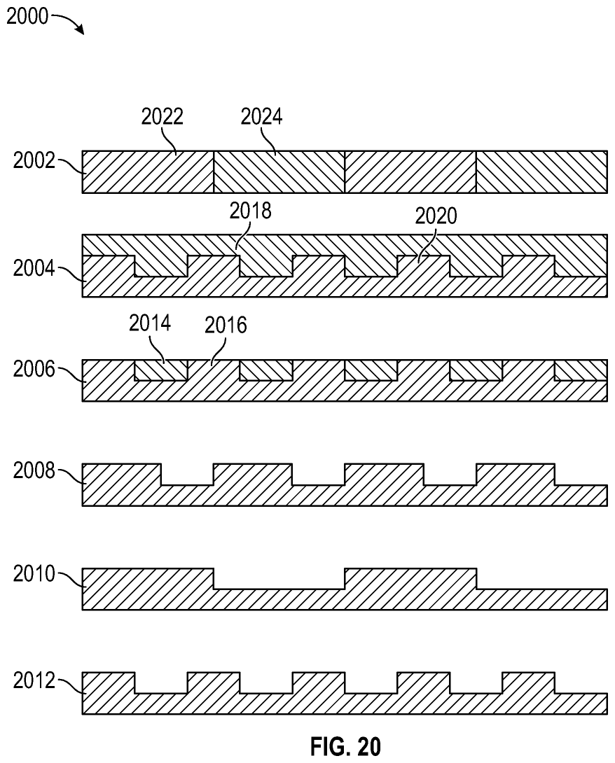

FIG. 20 through FIG. 24 illustrate the patterns that can be useful in preparing a clear tray aligner (which is a type of force member). The various patterns can be useful in modifying the aggregate force characteristic sufficient to affect the treatment plan. Thus, the patterns can be a force characteristic of a force member. In at least one embodiment, raised features in a pattern can be arranged in a stochastic, i.e. chaotic or random, pattern. One advantage of a stochastic pattern is that bias would be avoided in the force/displacement curve along certain axes that happen to align with periodic structures. In at least one embodiment, periods can be regular when the cross-section is taken orthogonal to an edge of a square in a checkered pattern or a hexagon in a honeycomb pattern. However, periods can be more complex when the cross-section is taken off-axis, diagonally, or in no particular orientation, and the force-displacement curves at these orientations differ from those taken along orthogonal axes.

To avoid such differences, a stochastic pattern may be used, which results in little to no bias favoring any given orientation. This can be advantageous for clear tray aligners, because the contact points (i.e. supports), and thus the orientations of the spans, can be rather indeterminate and changing during each stage of treatment or throughout the several stages of treatment. As such, a stochastic pattern may offer a more predictable force response that varies relatively little as a function of span orientation.

FIG. 20 shows several different cross-sectional patterns 2000, all of which resemble square waves due to abrupt changes in the thickness of the constituent materials.

In at least one embodiment, pattern 2008, pattern 2010, and pattern 2012 comprise a single material having a minimum thickness and a maximum thickness and no intermediate thicknesses.

In pattern 2010, the elevations and depressions have the same width with two different periods shown. In pattern 2008, the elevations are longer than the depressions.

Pattern 2002, pattern 2004, and pattern 2006 comprise two different materials, each modulus of elasticity differs between the two materials.

In pattern 2006, the second material 2014 fills depressions in the first material 2016 and remains exposed to the surface. In pattern 2004, both second material 2018 and first material 2020 have identical geometry and are mated such that each of the top and bottom surfaces exposes only a single material.

In pattern 2002, both first material 2022 and second material 2024 span the entire thickness of the sheet, but discontinuities exist in the plane of the sheet. Note that the pattern changes depending on the cross-section taken through the sheet.

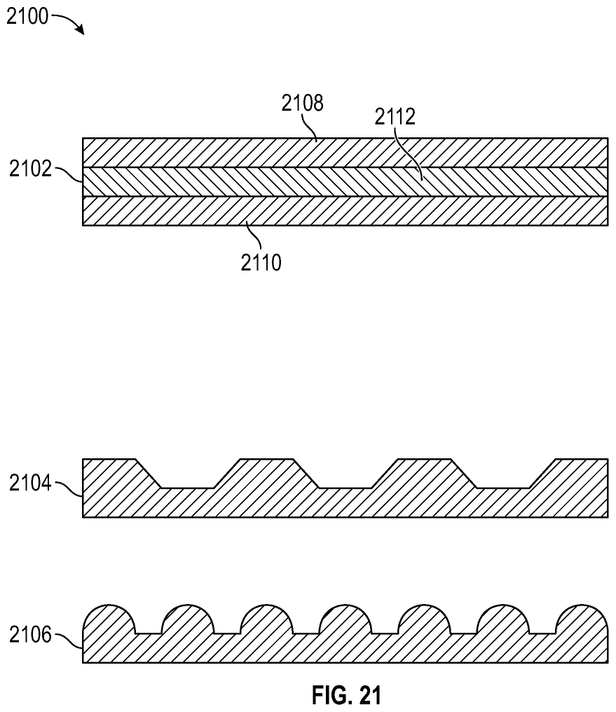

FIG. 21 shows patterns 2100 having a minimum thickness, a maximum thickness, and variable intermediate thicknesses. The pattern 2106 has semicircular features, while the pattern 2104 has trapezoidal features. Both are periodic. The pattern 2102 is a multi-layer sheet, wherein the outer layer (layer 2110 and layer 2108) have a first modulus of elasticity, and the inner layer 2112 has a second modulus of elasticity.

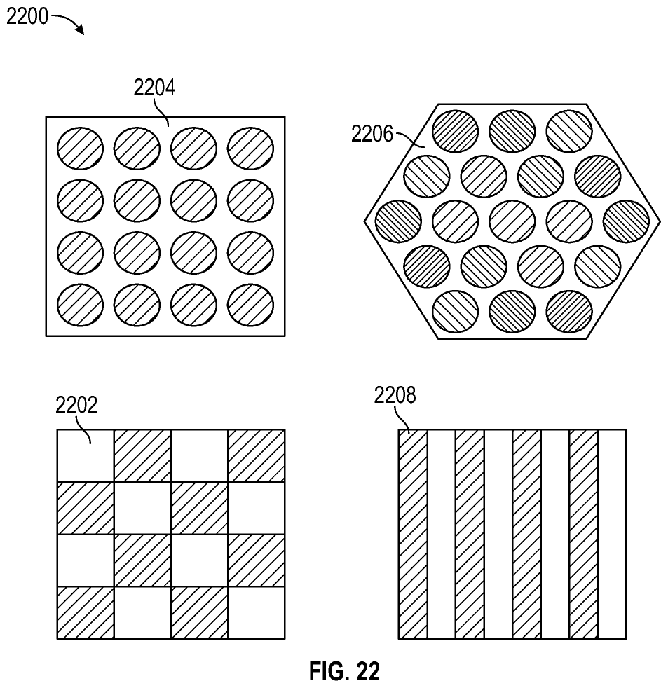

FIG. 22 shows a normal view of some different patterns 2200, including stripes in pattern 2208, checkers in pattern 2202, square dot pattern 2204, and hexagonal dot pattern 2206. The different shades can represent different overall thicknesses, different thicknesses within a single layer of material, or different moduli of elasticity. In at least one embodiment, 2208 can have a striped in a pattern that can be raised.

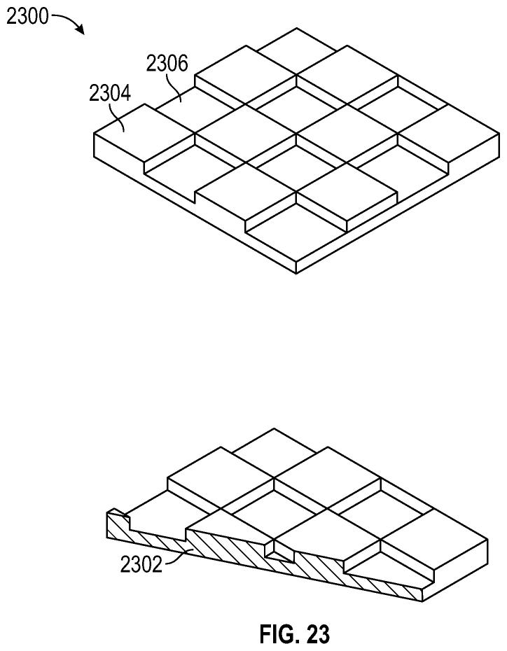

FIG. 23 shows a checkered pattern 2300 comprising a single material with alternating elevated square 2304 and depressed square 2306. The substrate is constant thickness. The cross-section 2302 is shown with checkered pattern 2300 sliced along a diagonal line. In the cross-section, the elevated and depressed segments have different lengths but occur in a repeating pattern. In at least one embodiment, the depressed square 2306 includes the substrate and the elevated square 2304 is a different material overlaid on the substrate.

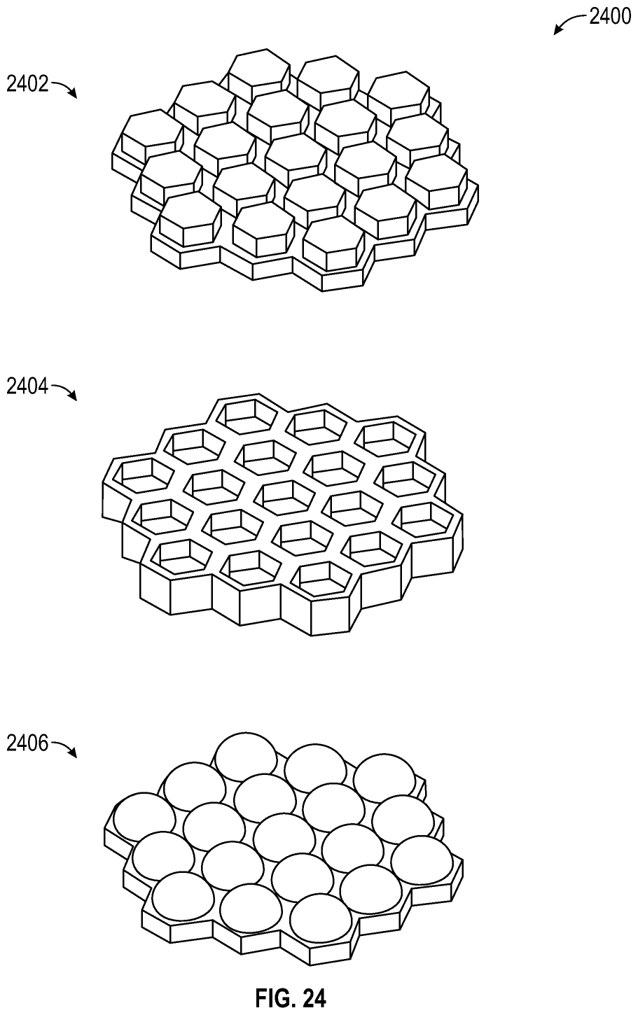

FIG. 24 shows various honeycomb patterns 2400. For example, pattern 2402 is comprised of elevated hexagons on a substrate of uniform thickness. Pattern 2404 is comprised of depressed hexagons on a substrate of uniform thickness. Pattern 2406 is comprised of hemispheres on a substrate of uniform thickness.

In at least one embodiment, the unit of the honeycomb is a hexagon (as opposed to a square) as shown in pattern 2402, and pattern 2404. In at least one embodiment, the pattern could be a hemisphere as in pattern 2406 or some other raised feature residing within the hexagon.

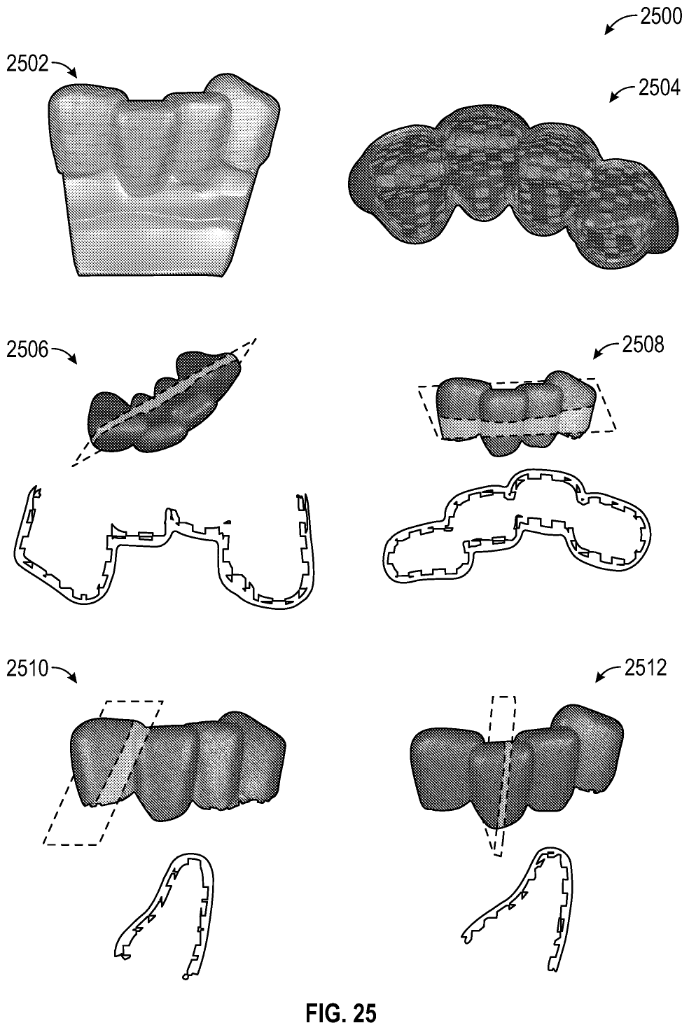

FIG. 25 illustrates an embodiment of a clear tray aligner 2500 having the checkered pattern of FIG. 23. View 2502 illustrates a portion of the clear tray aligner 2500 attached to the mandibular incisors.

View 2504 illustrates the clear tray aligner 2500 from the bottom, absent the teeth. View 2506 illustrates a cross-section of clear tray aligner 2500 taken along the coronal plane.

View 2508 illustrates a cross-section of clear tray aligner 2500 taken along the transverse plane. View 2510 illustrates a cross-section of one shell of a clear tray aligner 2500 taken along a sagittal plane slightly askew. View 2512 illustrates a cross-section of one shell of a clear tray aligner 2500 taken along a sagittal plane.

As shown, the checkered pattern is present on the non-visible/interior side of the clear tray aligner 2500 for strength and for reasons of patient comfort, thus presenting a smooth surface to the tongue and lips and reducing interference with appliances on the opposing arch. However, the checkered pattern, or other patterns such as honeycomb patterns 2402, 2404, or 2406, can have 3-dimensional relief on the outer surface, or on both inner and outer surfaces, or on neither inner nor outer surfaces of the CTA. One or both materials forming the pattern may be optically translucent or transparent, despite having different moduli of elasticity, thus allowing the natural shade of the teeth to show through and be considered “aesthetic”. In some embodiments, the different materials may be substantially similar in transparency or other appearance characteristics (such as tint or hue), thus making the patterns substantially invisible to the eye. This attribute can further improve the aesthetics of the appliance.

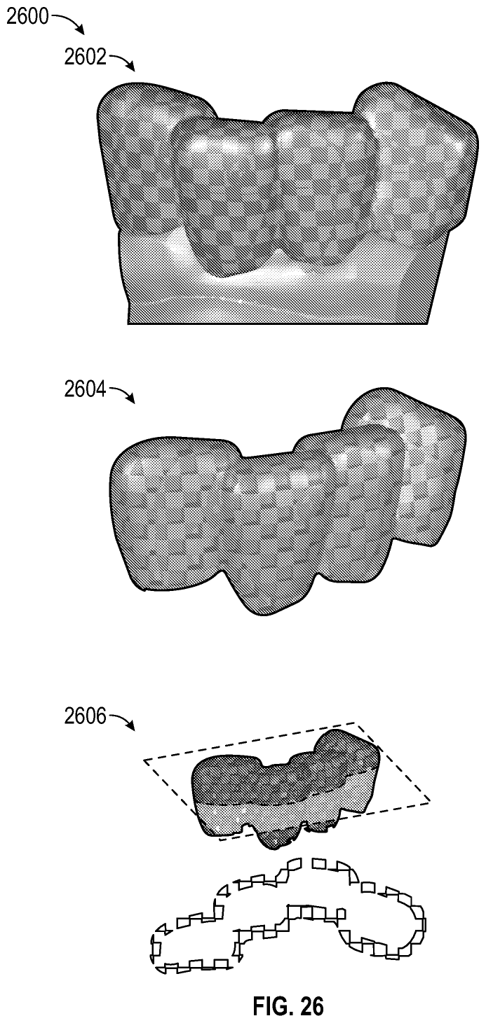

FIG. 26 illustrates an embodiment of a clear tray aligner 2600. The embodiment can have the structure of pattern 2002 in FIG. 20 where the checkers are representing two different materials that are placed alternately (interleaved) in the same curved plane of the sheet (or shell) formed around the teeth. View 2602 illustrates a front view of clear tray aligner 2600 shown attached to the mandibular incisors. View 2604 illustrates a facial view of the clear tray aligner 2600. View 2606 illustrates a cross-section of a shell of clear tray aligner 2600 taken along the transverse plane.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the singular or plural number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

### List of Illustrative Embodiments

1. A method comprising:

receiving, by a computing device, data indicative of a virtual dentition of an oral cavity of a patient, the data indicative of the virtual dentition;

receiving, by the computing device, data indicative of a first aggregate force characteristic of a force member in a first configuration, wherein the force member comprises:
a first segment having a first end, the first segment having a first force characteristic, and
a second segment having a first end, the second segment having a second force characteristic, wherein the first end of the first segment is attached to the first end of the second segment;

determining a first force vector of a selected point in a first position on the virtual dentition of the oral cavity based on the first aggregate force characteristic of the force member in the first configuration;

determining a second force vector of the selected point in a second position on the virtual dentition based on the first aggregate force characteristic of the force member in the first configuration, the second position corresponding to a tooth movement after a treatment plan;

determining a condition of whether the second force vector (or force magnitude thereof) is within 90 percent of the first force vector (or force magnitude thereof) at 50 percent of displacement between the first position and the second position;

performing, by the computing device, an operation based on the condition.
2. The method of embodiment 1, further comprising:

receiving, by the computing device, data indicative of a second aggregate force characteristic of the force member in a second configuration;

determining a third force vector of the selected point in the first position on the virtual dentition based on the second aggregate force characteristic of the force member in the second configuration;

determining a fourth force vector of the selected point in the second position on the virtual dentition based on the second aggregate force characteristic;

wherein determining the condition also comprises whether the fourth force vector (or force magnitude thereof) is within 90 percent of the third force vector (or force magnitude thereof) at 50 percent of displacement between the first position and the second position.
3. The method of embodiment 2, wherein the first aggregate force characteristic and second aggregate force characteristic differ based on changes of the first force characteristic and the second force characteristic in the force member.
4. The method of any of the preceding embodiments, wherein the selected point corresponds to a position of an orthodontic bracket that is configured to engage with the first segment.
5. The method of any of the preceding embodiments, wherein the first force characteristic or second force characteristic is selected from modulus of elasticity, cross-sectional dimension, length, orientation, geometric shape, or combinations thereof.
6. The method of any of the preceding embodiments, wherein performing the operation comprises:

outputting, by the computing device, for display, a graphical user interface indicating at least a portion of the virtual dentition in the second position.
7. The method of embodiment 6, further comprising: outputting, via the display, the graphical user interface that indicates whether the condition is met.
8. The method of any of the preceding embodiments, wherein performing the operation comprises:

determining, by the computing device, one or more treatment plans for the patient based at least in part on the determined second force vector.
9. The method of any of the preceding embodiments, wherein performing the operation comprises:

recommending changes to the first force characteristic or the second force characteristic of the force member that affects the fourth force vector.
10. The method of any of the preceding embodiments, wherein performing the operation comprises:

determining, by the computing device, based on the second force vector, whether a position and orientation of a tooth of the virtual dentition is in a targeted position.
11. The method of any of the preceding embodiments, further comprising:

modifying, by the computing device, the force member on the virtual dentition to change one or more force characteristics of the force member; and

determining, by the computing device, based on the modified force member, whether the virtual dentition is in a targeted position.
12. The method of embodiment 11, wherein the changes result from a user interaction with a graphical user interface.
13. The method of any of the preceding embodiments, wherein performing the operation comprises:

transmitting a representation of the force member to a manufacturing system.
14. The method of embodiment 13, wherein performing the operation comprises: transmitting a representation of an orthodontic bracket position and orientation to the manufacturing system.
15. The method of embodiment 13, further comprising contacting the force member with at least a portion of a dentition of a patient.
16. The method of any of the preceding embodiments, wherein the first segment is different from the second segment.
17. The method of any of the preceding embodiments, wherein the force member further comprises a third segment adjacent to the first segment, wherein a first angle formed between the third segment and the first segment is different from a second angle formed between the first segment and the second segment.
18. The method of any of the preceding embodiments, wherein the first force characteristic or second force characteristic comprises a geometric cross section of the force member.
19. The method of any of the preceding embodiments, wherein the virtual dentition comprises data indicative of at least one of a virtual mandibular arch representing a mandibular arch of the patient or a virtual maxillary arch representing a maxillary arch of the patient.
20. The method of any of the preceding embodiments, wherein a force vector relates to a span of the force member between the selected point and a first point corresponding to a position of a first adjacent orthodontic bracket.
21. The method of embodiment 20, wherein the force vector relates to a span of the force member between the first point and a second point corresponding to a position of a second adjacent orthodontic bracket.
22. The method of embodiment 20, wherein the span comprises a portion of a plurality of segments.
23. The method of any of the preceding embodiments, wherein determining a force vector based on an aggregate force characteristic of a force member further comprises determining a force vector for a portion of the force member.
24. The method of embodiment 23, wherein the portion is a span.
25. The method of embodiment 24, wherein determining the force vector comprises:

receiving a selected span between two selected points, wherein a selected point corresponds to a support;

determining whether force characteristics of the span at a support are determinable from a datastore;

determining the force vector at the supports using information in the datastore if the span force characteristics are determinable from the datastore;

determining whether the force vector of the support is within a support threshold;

modifying one or more force characteristics of a segment within the span based on the force vector not being within the support threshold.
26. The method of embodiment 25, further comprising: determining an aggregate force characteristic for a plurality of spans based on the force vector of the support being within the support threshold.
27. The method of embodiment 25, further comprising performing finite element analysis for the entire force member to determine the aggregate force characteristic in response to the span force characteristic not being determinable from the datastore.
28. The method of embodiment 25, wherein the support threshold is based on the treatment plan for a tooth.
29. The method of embodiment 25, further comprising: determining if a change in the force vector between iterations is decreasing within a threshold, and if not, then performing finite element analysis for the force member.
30. The method of embodiment 29, further comprising modifying one or more force characteristics of the segment based on the change between iterations being decreasing.
31. A non-transitory computer-readable storage medium including instructions that, when processed by a computer, configure the computer to perform the method of any of the preceding embodiments.
32. A system, comprising:

a computing device comprising:

a processor; and

a memory storing instructions that, when executed by the processor, configure the computing device to:
receive data indicative of a virtual dentition of an oral cavity of a patient, the data indicative of the virtual dentition;
receive data indicative of a first aggregate force characteristic of a force member in a first configuration, wherein the force member comprises:
   a first segment having a first end, the first segment having a first force characteristic, and
   a second segment having a first end, the second segment having a second force characteristic, wherein the first end of the first segment is attached to the first end of the second segment;
determine a first force vector of a selected point in a first position on the virtual dentition of the oral cavity based on the first aggregate force characteristic of the force member in the first configuration;
determine a second force vector of the selected point in a second position on the virtual dentition based on the first aggregate force characteristic of the force member in the first configuration, the second position corresponding to tooth movement after a treatment plan;
determine a condition of whether the second force vector (or force magnitude thereof) is within 90 percent of the first force vector (or force magnitude thereof) at 50 percent of displacement between the first position and the second position;
perform an operation based on the condition.
33. The system of any of the preceding embodiments, wherein the first aggregate force characteristic and a second aggregate force characteristic differ based on changes of the first force characteristic and the second force characteristic in the force member.
34. The system of any of the preceding embodiments, wherein instructions that, when executed by the processor, configure the computing device to further:

receive, by the computing device, data indicative of the second aggregate force characteristic of the force member in a second configuration;

determine a third force vector of the selected point in the first position on the virtual dentition based on the second aggregate force characteristic of the force member in the second configuration;

determine a fourth force vector of the selected point in the second position on the virtual dentition based on the second aggregate force characteristic;

wherein determine the condition also comprises whether the fourth force vector (or force magnitude thereof) is within 90 percent of the third force vector (or force magnitude thereof) at 50 percent of displacement between the first position and the second position.
35. The system of embodiment 34, wherein performing the operation comprises:

recommending changes to the first force characteristic or the second force characteristic of the force member that affects the fourth force vector.
36. The system of any of the preceding embodiments, wherein the selected point corresponds to a position of an orthodontic bracket that is configured to engage with the first segment.
37. The system of any of the preceding embodiments, wherein the first force characteristic or second force characteristic is selected from modulus of elasticity, cross-sectional dimension, length, orientation, geometric shape, or combinations thereof.
38. The system of any of the preceding embodiments, further comprising a display, wherein performing the operation comprises:

outputting, via the display, a graphical user interface indicating at least a portion of the virtual dentition in the second position.
39. The system of any of the preceding embodiments, wherein the instructions, when executed by the processor, configure the computing device to perform the method of any of embodiment 1 to embodiment 31.
40. The system of any of the preceding embodiments, further comprising: a datastore communicatively coupled to the computing device, wherein the determining a force vector comprises:

receiving a selected span between two selected points, wherein the selected point corresponds to a support;

determining whether a force characteristic of the span is determinable from the datastore;

determining the force vector at the supports using information in the datastore if the span force characteristics are determinable from the datastore;

determining whether the force vector of a support is within a support threshold;

modifying one or more force characteristics of a segment within the span based on the force vector not being within the support threshold.
41. The system of embodiment 40, further comprising performing finite element analysis for an entire force member to determine the aggregate force characteristic in response to the span force characteristic not being determinable from the datastore.
42. The system of any of the preceding embodiments, further comprising a manufacturing system, wherein performing the operation comprises:

transmitting a representation of the force member to the manufacturing system.
43. The system of any of the preceding embodiments, wherein the manufacturing system is configured to manufacture the force member meeting the condition.
44. The system of any of the preceding embodiments, wherein the force member is an arch wire.
45. The system of any of the preceding embodiments, wherein the force member is a clear tray aligner.

45a. The system of embodiment 45, wherein the force characteristic is a pattern of varying thicknesses in a three-dimensional space.
45b. The system of any of the preceding embodiments, wherein the pattern is a stochastic pattern.
45c. The system of any of the preceding embodiments, wherein the pattern comprises a honeycomb pattern and a raised or depressed hexagonal pattern.
46. The system of embodiment 45, wherein the first segment of the force member is a depressed square of a checkered pattern and a second segment is an elevated square of the checkered pattern.
47. The system of embodiment 45, wherein the first segment of the force member is planar, and at least a portion of the second segment is elevated relative to a plane of the first segment.
48. The system of embodiment 45, wherein the first segment of the force member is adjacent to the second segment without any overlaid portion.
49. The system of embodiment 43, further comprising a patient, wherein the force member is releasably attached to the patient.
50. The system of any of the preceding embodiments, wherein performing the operation comprises:

determining, by the computing device, one or more treatment plans for the patient based at least in part on the determined second force vector.
51. The system of any of the preceding embodiments, wherein performing the operation comprises:

determining, by the computing device, based on the second force vector, whether a position and orientation of a tooth of the virtual dentition is in a targeted position.
52. The system of any of the preceding embodiments, wherein instructions that, when executed by the processor, configure the computing device to further:

modify the force member on the virtual dentition to change one or more force characteristics of the force member; and

determine, based on the modified force member, whether the virtual dentition is in a targeted position.
53. The system of any of the preceding embodiments, wherein the first segment is different from the second segment.
54. The system of any of the preceding embodiments, wherein the first force characteristic or second force characteristic comprises a geometric cross section of the force member.
55. The system of any of the preceding embodiments, wherein the virtual dentition comprises data indicative of at least one of a virtual mandibular arch representing a mandibular arch of the patient or a virtual maxillary arch representing a maxillary arch of the patient.

1. A method comprising:
receiving, by a computing device, data indicative of a virtual dentition of an oral cavity of a patient, the data indicative of the virtual dentition;
receiving, by the computing device, data indicative of a first aggregate force characteristic of a force member in a first configuration, wherein the force member comprises:
a first segment having a first end, the first segment having a first force characteristic, and
a second segment having a first end, the second segment having a second force characteristic, wherein the first end of the first segment is attached to the first end of the second segment;
determining a first force vector of a selected point in a first position on the virtual dentition of the oral cavity based on the first aggregate force characteristic of the force member in the first configuration;
determining a second force vector of the selected point in a second position on the virtual dentition based on the first aggregate force characteristic of the force member in the first configuration, the second position corresponding to a tooth movement after a treatment plan;
determining a condition of whether the second force vector is within 90 percent of the first force vector at 50 percent of displacement between the first position and the second position;
performing, by the computing device, an operation based on the condition.

2. The method of claim 1, further comprising:
receiving, by the computing device, data indicative of a second aggregate force characteristic of the force member in a second configuration;
determining a third force vector of the selected point in the first position on the virtual dentition based on the second aggregate force characteristic of the force member in the second configuration;
determining a fourth force vector of the selected point in the second position on the virtual dentition based on the second aggregate force characteristic;
wherein determining the condition also comprises whether the fourth force vector is within 90 percent of the third force vector at 50 percent of displacement between the first position and the second position.

3. The method of claim 2, wherein the first aggregate force characteristic and the second aggregate force characteristic differ based on changes of the first force characteristic and the second force characteristic in the force member.

4. The method of claim 1, wherein the selected point corresponds to a position of a support that is configured to engage with the first segment.

5. The method of claim 1, wherein the first force characteristic or second force characteristic is selected from modulus of elasticity, cross-sectional dimension, length, orientation, geometric shape, pattern, or combinations thereof.

6. The method of claim 1, wherein performing the operation comprises:
outputting, by the computing device, for display, a graphical user interface indicating at least a portion of the virtual dentition in the second position, wherein the graphical user interface that indicates whether the condition is met.

7. The method of claim 2, wherein performing the operation comprises:
recommending changes to the first force characteristic or the second force characteristic of the force member that affects the fourth force vector.

8. The method of claim 1, further comprising:
modifying, by the computing device, the force member on the virtual dentition to change one or more force characteristics of the force member; and
determining, by the computing device, based on the modified force member, whether the virtual dentition is in a targeted position.

9. The method of claim 8, wherein determining a force vector based on an aggregate force characteristic of a force member further comprises determining a force vector for a portion of the force member, wherein the portion is a span.

10. The method of claim 9, wherein determining the force vector comprises:
receiving a selected span between two selected points, wherein a selected point corresponds to a support;
determining whether force characteristics of the span at a support are determinable from a datastore;
determining the force vector at the support using information in the datastore if the span force characteristics are determinable from the datastore;
determining whether the force vector of the support is within a support threshold;
modifying one or more force characteristics of a segment within the span based on the force vector not being within the support threshold.

11. The method of claim 9, further comprising: determining an aggregate force characteristic for a plurality of spans based on the force vector of the support being within the support threshold.

12. The method of claim 9, further comprising performing finite element analysis for an entire force member to determine the aggregate force characteristic in response to the span force characteristic not being determinable from the datastore.

13. A system, comprising:
a computing device comprising:
a processor; and
a memory storing instructions that, when executed by the processor, configure the computing device to:
receive data indicative of a virtual dentition of an oral cavity of a patient, the data indicative of the virtual dentition;
receive data indicative of a first aggregate force characteristic of a force member in a first configuration, wherein the force member comprises:
a first segment having a first end, the first segment having a first force characteristic, and
a second segment having a first end, the second segment having a second force characteristic, wherein the first end of the first segment is attached to the first end of the second segment;
determine a first force vector of a selected point in a first position on the virtual dentition of the oral cavity based on the first aggregate force characteristic of the force member in the first configuration;
determine a second force vector of the selected point in a second position on the virtual dentition based on the first aggregate force characteristic of the force member in the first configuration, the second position corresponding to tooth movement after a treatment plan;
determine a condition of whether the second force vector is within 90 percent of the first force vector at 50 percent of displacement between the first position and the second position;
perform an operation based on the condition.

14. The system of claim 13, wherein the instructions that, when executed by the processor, configure the computing device to further:
receive, by the computing device, data indicative of the second aggregate force characteristic of the force member in a second configuration;
determine a third force vector of the selected point in the first position on the virtual dentition based on the second aggregate force characteristic of the force member in the second configuration;
determine a fourth force vector of the selected point in the second position on the virtual dentition based on the second aggregate force characteristic;
wherein determine the condition also comprises whether the fourth force vector is within 90 percent of the third force vector at 50 percent of displacement between the first position and the second position.

15. The system of claim 13, further comprising a display, wherein performing the operation comprises:
outputting, via the display, a graphical user interface indicating at least a portion of the virtual dentition in the second position.

16. The system of claim 13, further comprising: a datastore communicatively coupled to the computing device, wherein the determining a force vector comprises:
receiving a selected span between two selected points, wherein the selected point corresponds to a support;
determining whether a force characteristic of the span is determinable from the datastore;
determining the force vector at the supports using information in the datastore if the span force characteristics are determinable from the datastore;
determining whether the force vector of a support is within a support threshold;
modifying one or more force characteristics of a segment within the span based on the force vector not being within the support threshold.

17. The system of claim 16, further comprising performing finite element analysis for an entire force member to determine the aggregate force characteristic in response to the span force characteristic not being determinable from the datastore.

18. The system of claim 13, further comprising a manufacturing system, wherein performing the operation comprises:
transmitting a representation of the force member to the manufacturing system.

19. The system of claim 18, wherein the manufacturing system is configured to manufacture the force member meeting the condition.

20. The system of claim 13, wherein the force member is a clear tray aligner and the force characteristic is a pattern of varying thicknesses in a three-dimensional space.
